(19) United States
(12) Patent Application Publication
(10) Pub. No.: US 2025/0212169 A1
(43) Pub. Date: Jun. 26, 2025

(54) VEHICLE INFORMATION AIDED ROAMING AND PLMN SELECTION IN VEHICULAR UES FOR BORDER CROSSINGS

(71) Applicant: QUALCOMM Incorporated, San Diego, CA (US)

(72) Inventors: Mohsen BAHRAMI, Carlsbad, CA (US); Soumya DAS, San Diego, CA (US)

(21) Appl. No.: 18/391,475

(22) Filed: Dec. 20, 2023

(51) Int. Cl. H04W 64/00; H04W 8/22; H04W 84/04

(52) U.S. Cl. CPC H04W 64/006; H04W 8/22; H04W 84/042

(57) ABSTRACT

Vehicle information aided roaming and PLMN selection in vehicular UEs for border crossings is described. An apparatus is configured to calculate distances from a location of the UE to a crossing of a border between a first and a second region. The distances are based on a corresponding set of border points and a GNSS location fix for the UE. The apparatus is configured to estimate an elapsed time the UE crossed the border based on at least one of a current heading of a vehicle associated with the UE, at least one distance, or a current speed of the UE. The apparatus is configured to provide, for a network entity, based on the elapsed time at which the UE crossed the border and a crossing threshold condition, an indication of a regional communication code of the second region associated with roaming of the UE in the second region.

### TECHNICAL FIELD

The present disclosure relates generally to communication systems, and more particularly, to wireless communications utilizing roaming.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may comprise a user equipment (UE), and the method may be performed at/by a UE. The apparatus is configured to calculate a set of distances from a location of the UE to at least one crossing of a border between a first region and a second region, where the UE is initially located in the first region, where the set of distances is based on a corresponding set of border points and a global navigation satellite system (GNSS) location fix for the UE. The apparatus is configured to estimate an elapsed time at which the UE crossed the border based on at least one of a current heading of a vehicle associated with the UE, at least one distance of the set of distances, or a current speed of the UE. The apparatus is configured to provide, for a network entity and based on the elapsed time at which the UE crossed the border and a crossing threshold condition, an indication of a regional communication code of the second region associated with roaming of the UE in the second region.

In the aspect, the method includes calculating a set of distances from a location of the UE to at least one crossing of a border between a first region and a second region, where the UE is initially located in the first region, where the set of distances is based on a corresponding set of border points and a GNSS location fix for the UE. The method includes estimating an elapsed time at which the UE crossed the border based on at least one of a current heading of a vehicle associated with the UE, at least one distance of the set of distances, or a current speed of the UE. The method includes providing, for a network entity and based on the elapsed time at which the UE crossed the border and a crossing threshold condition, an indication of a regional communication code of the second region associated with roaming of the UE in the second region.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a border crossing detection utilizing GNSS.

FIG. 5 is a call flow diagram for wireless communications, in accordance with various aspects of the present disclosure.

FIG. 6 is a diagram illustrating an example of vehicle information aided roaming and public land mobile network (PLMN) selection in vehicular UEs for border crossings, in accordance with various aspects of the present disclosure.

FIG. 7 is a diagram illustrating example configurations for vehicle information aided roaming and PLMN selection in vehicular UEs for border crossings, in accordance with various aspects of the present disclosure.

FIG. 8 is a diagram illustrating example configurations for vehicle information aided roaming and PLMN selection in vehicular UEs for border crossings, in accordance with various aspects of the present disclosure.

FIG. 9 is a diagram illustrating example configurations for vehicle information aided roaming and PLMN selection in vehicular UEs for border crossings, in accordance with various aspects of the present disclosure.

FIG. 10 is a diagram illustrating example configurations for vehicle information aided roaming and PLMN selection in vehicular UEs for border crossings, in accordance with various aspects of the present disclosure.

FIG. 11 is a diagram illustrating example configurations for vehicle information aided roaming and PLMN selection in vehicular UEs for border crossings, in accordance with various aspects of the present disclosure.

FIG. 12 is a diagram illustrating example configurations for vehicle information aided roaming and PLMN selection in vehicular UEs for border crossings, in accordance with various aspects of the present disclosure.

FIG. 13 is a flowchart of a method of wireless communication, in accordance with various aspects of the present disclosure.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example network entity.

### DETAILED DESCRIPTION

Wireless communication networks may be designed to support communications between network nodes/entities (e.g., base stations, gNBs, core network entities, etc.) and UEs. For instance, a network node/entity and a UE in a wireless communication network may communicate in various configurations to account for UE mobility. As an example, a UE may connect to a roaming cell when the UE moves into a different region, such as a different country via a land border crossing.

However, PLMN selection and radio access technology (RAT)/frequency band scans during land border crossings may lead to service loss and interruption based on roaming agreements and cross-border network setups. As one example, this may adversely impact certain connected vehicle services with service continuity considerations such as tele-operated driving. Additionally, false-positive border crossing indications and lack of granularity in determinations for border approaches/crossings may decrease reliability and speed of border crossing detections. Further, when a UE simply utilizes GNSS fixes and a straight-line distance to a border region, e.g., for a vehicular UE, to detect when the UE is in a new region/country, considerations such as road geometry/traffic situations, vehicle heading/direction, etc., that are not accounted for may lead to scenarios in which the detection time may be delayed (or in which triggering conditions would not be met), and the UE may fall back to prior PLMN searches, further delaying service.

Various aspects relate generally to wireless communications utilizing roaming. Some aspects more specifically relate to vehicle information aided roaming and PLMN selection in vehicular UEs for border crossings. In some examples, a UE may utilize GNSS fixes to prompt a modem to trigger an indication of a new regional communication code, e.g., a mobile country code (MCC) to an upper network layer(s) for scanning RATs/frequency bands (e.g., full/limited) based on the new region/country band policy when the UE is further than a given distance (e.g., 200 m) inside the different/new region or country. In other examples, available vehicle sensor information (e.g., vehicle heading/trajectory), navigation information (e.g., history or real-time information, such as vehicle route/trip information, road geometry/traffic information, etc.), and vehicle camera information (e.g., for road images, road traffic signs, and/or the like), in addition to GNSS information (e.g., vehicle location and speed, etc.) may be utilized to enable a modem to more quickly and accurately select a PLMN in a new region/country when a vehicle UE is crossing the region/country border by land.

Particular aspects of the subject matter described in this disclosure can be implemented to realize one or more of the following potential advantages. In some examples, by incorporating additional information with GNSS fixes, the described techniques can be used to improve the reliability of border mode determinations for vehicular UEs. In some examples, by incorporating vehicle information together with UE cell history, vehicle trip history, and/or road geometry/characteristics information, the described techniques can be used to improve the performance, such as lower threshold distances for border crossing detection, as well as the accuracy of border mode determinations for vehicular UEs, such as fewer false alarm border mode detections.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

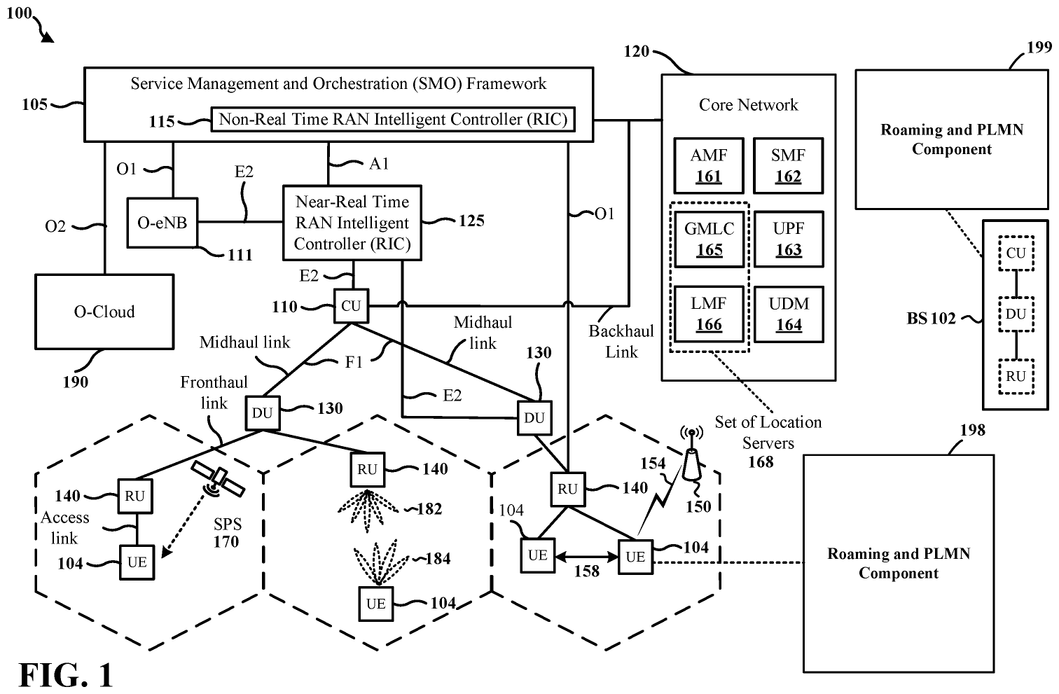

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface).

For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a roaming and PLMN component 198 (“component 198”) that may be configured to calculate a set of distances from a location of the UE to at least one crossing of a border between a first region and a second region, where the UE is initially located in the first region, where the set of distances is based on a corresponding set of border points and a GNSS location fix for the UE. The component 198 may be configured to estimate an elapsed time at which the UE crossed the border based on at least one of a current heading of a vehicle associated with the UE, at least one distance of the set of distances, or a current speed of the UE. The component 198 may be configured to provide, for a network entity and based on the elapsed time at which the UE crossed the border and a crossing threshold condition, an indication of a regional communication code of the second region associated with roaming of the UE in the second region. The component 198 may be configured to obtain traffic information associated with the vehicle associated with the UE. The component 198 may be configured to identify that the location of the UE is in the second region based on an updated GNSS location fix. The component 198 may be configured to increase a time interval for calculating distances of the set of distances from the location of the UE to the at least one crossing of the border between the first region and the second region. The component 198 may be configured to calculate another set of distances from the location of the UE to the at least one crossing of the border between the first region and the second region. The component 198 may be configured to estimate another elapsed time at which the UE crossed the border based on at least one of another current heading of the vehicle associated with the UE, at least one other distance of the another set of distances, or another current speed of the UE. The component 198 may be configured to obtain, from an inference engine and based on at least one vehicle camera input of a camera of the vehicle, an inference of a road traffic status for a road associated with the UE of the vehicle, where the inference of the road traffic status indicates an amount of traffic that meets a traffic threshold condition. The component 198 may be configured to obtain, based on at least one vehicle camera input of a camera of the vehicle, a road indication of a road type or a road geometry for a road associated with the UE of the vehicle. The component 198 may be configured to identify that the location of the UE is in the first region based on an updated GNSS location fix. The component 198 may be configured to obtain, based on at least one vehicle camera input of a camera of the vehicle, a sign indication of a road sign for a road associated with the UE of the vehicle, where the sign indication of the road sign is indicative of a distance from the location of the UE to the at least one crossing of the border between the first region and the second region. The component 198 may be configured to receive, from the network entity, a configuration indicative of a switch to a cell associated with the regional communication code of the second region. The component 198 may be configured to switch to the cell based on the configuration. In certain aspects, the base station 102 may have a roaming and PLMN component 199 (“component 199”) that may be configured to receive, from a UE and based on an elapsed time at which the UE crossed a border from a first region to a second region and a crossing threshold condition, an indication of a regional communication code of the second region associated with roaming of the UE in the second region. The component 199 may be configured to provide, for the UE and based on the indication of the regional communication code of the second region, a configuration indicative of a switch to a cell associated with the regional communication code of the second region. The component 199 may be configured to communicate with the UE based on the switch to the cell. Accordingly, for vehicle information aided roaming and PLMN selection in vehicular UEs for border crossings in which a UE may utilize GNSS fixes to prompt a modem to trigger an indication of a new regional communication code to an upper network layer(s) for scanning RATs/frequency bands (e.g., full/limited) based on the new region band policy when the UE is further than a given distance inside the different/new region, and may utilize available vehicle sensor information, navigation information, and vehicle camera information, in addition to GNSS information to enable a modem to more quickly and accurately select a PLMN in a new region when a vehicle UE is crossing the region border by land.

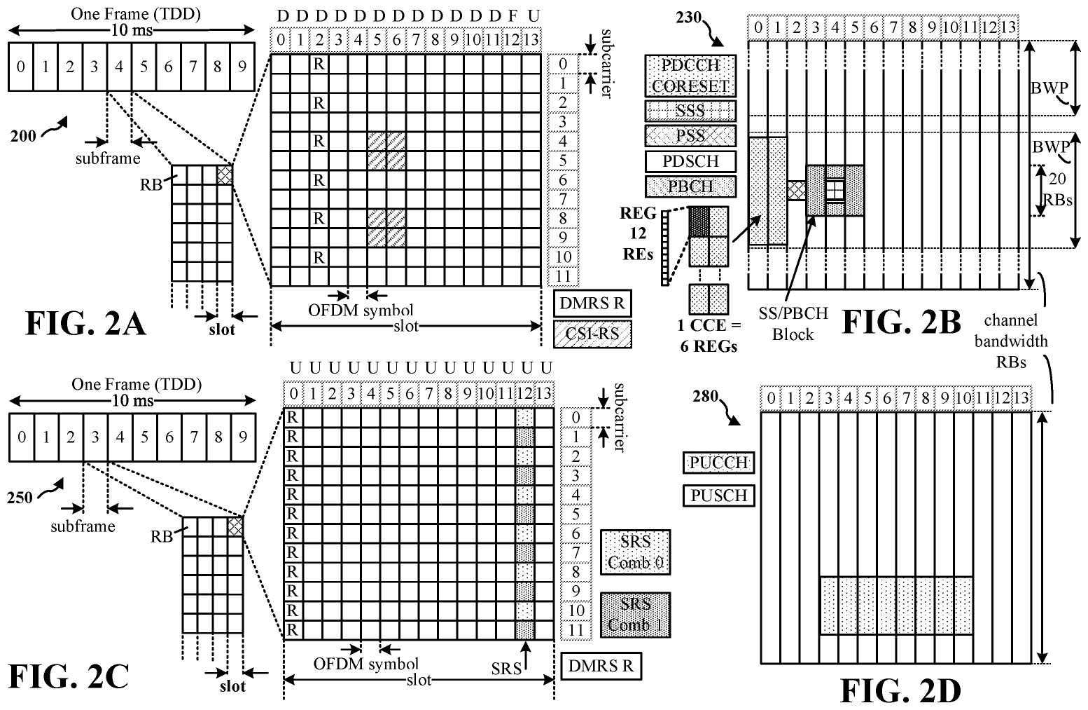

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2ª *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

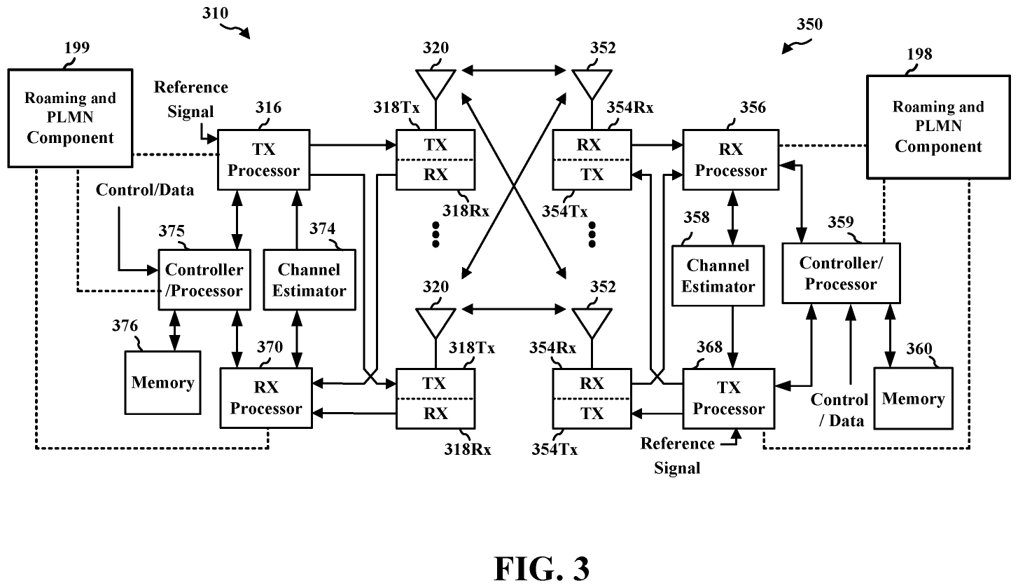

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A network node/entity and a UE in a wireless communication network may communicate in various configurations to account for UE mobility. As an example, a UE may connect to a roaming cell when the UE moves into a different region, such as a different country via a land border crossing. However, PLMN selection and RAT/frequency band scans during land border crossings may lead to service loss and interruption based on roaming agreements and cross-border network setups. As one example, this may adversely impact certain connected vehicle services with service continuity considerations such as tele-operated driving. Additionally, false-positive border crossing indications and lack of granularity in determinations for border approaches/crossings may decrease reliability and speed of border crossing detections. Further, when a UE simply utilizes GNSS fixes and a straight-line distance to a border region, e.g., for a vehicular UE, to detect when the UE is in a new region/country, considerations such as road geometry/traffic situations, vehicle heading/direction, etc., that are not accounted for may lead to scenarios in which the detection time may be delayed (or in which triggering conditions would not be met), and the UE may fall back to prior PLMN searches, further delaying service.

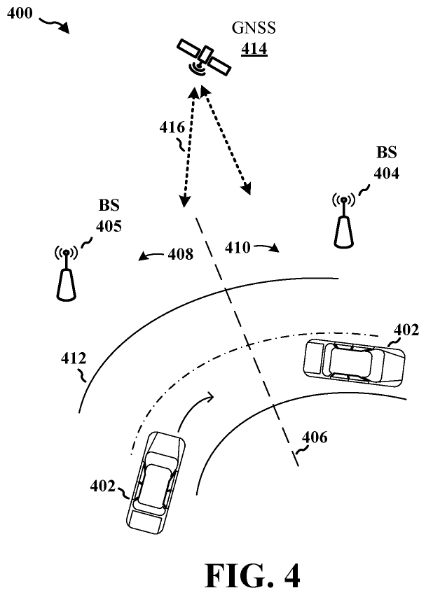

FIG. 4 is a diagram 400 illustrating an example of a border crossing detection utilizing GNSS. The diagram 400 shows a vehicular UE 402 that crosses a land border 406 via a roadway 412 from a first region 408, having a network entity (e.g., a base station 405) initially serving the vehicular UE 402, to a second region 410, having a network entity (e.g., a base station 404) on which the vehicular UE 402 may be served via roaming after crossing the land border 406.

As noted above, a UE, such as the vehicular UE 402, may utilize a GNSS 414 fix 416 and a straight-line distance to a border region to detect when the vehicular UE 402 is in a new region/country (e.g., the second region 410 after crossing the land border 406. However, considerations such as road geometry/traffic situations associated with the roadway 412, vehicle heading/direction, etc., may not be accounted for, and may lead to scenarios in which the detection time for crossing the land border 406 may be delayed (or in which triggering conditions would not be met), and the vehicular UE 402 may fall back to prior PLMN searches, further delaying service.

Additionally, PLMN selection and RAT/frequency band scans during land border crossings may lead to service loss and interruption based on roaming agreements and cross-border network setups such as between the network of the base station 404 in the second region 410 and the base station 405 in the first region 408. Such conflicting setups may adversely impact certain connected vehicle services with service continuity considerations such as tele-operated driving.

Aspects herein, however, provide improvements for such issues. Aspect provide for the use of vehicle heading/trajectory, navigation information (e.g., history or real-time information such as vehicle route/trip information and road traffic information), GNSS (e.g., vehicle location and speed) can be used to accelerate selection of a PLMN) in a new country or region when a vehicle is crossing the country or region border by land.

In vehicular UEs, the modem for different telematics applications (e.g., V2X, emergency services, etc.) may obtain information from vehicle sensors, an advanced driver assistance system (ADAS) module, and/or other electronic control units (ECUs) of/within the vehicle through Ethernet interfaces or Controller Area Network (CAN) buses. For example, eCall/NG-eCall, which may be supplemented by a Minimum Set of Data (MSD), and may include vehicle location and direction information which are obtained from GNSS and an inertial measurement unit (IMU) may be utilized. As another example, an intelligent transportation systems (ITS) stack for basic safety messages (BSMs), which may use different information such as steering angle of steering wheel, transmission/brake system status, etc., may be utilized. Such vehicle information together with a UE cell history, a vehicle trip history, road geometry/characteristics information, and/or the like, may enhance the performance, as well as the accuracy, of border mode detections for vehicular UEs.

For instance, a lower threshold distance may be configured for vehicular UEs so that their modems more quickly indicate the detection of border crossing for a new region/country (and an associated new regional communication code/MCC) to upper layers of a wireless communications network. This may improve the performance of border mode detections for vehicular UEs, e.g., for different road geometry/characteristics, a modem may not have to wait to trigger an indication of the new region/country (and an associated new regional communication code/MCC) to upper layers when UE is at least at given distance inside the new region country. Similarly, Telematics Control Units (e.g., because of C-V2X applications) may be equipped with higher precision GNSS modules compared to mobile devices, and therefore the modems in vehicular UEs may not benefit from speeding up GNSS fix requests.

The aspects herein for vehicle information aided roaming and PLMN selection in vehicular UEs for border crossings may enable a UE to utilize GNSS fixes to prompt a modem to trigger an indication of a new regional communication code, e.g., an MCC) to an upper network layer(s) for scanning RATs/frequency bands (e.g., full/limited) based on the new region/country band policy when the UE is further than a given distance inside the different/new region or country. Aspects also provide for available vehicle sensor information (e.g., vehicle heading/trajectory), navigation information (e.g., history or real-time information, such as vehicle route/trip information, road geometry/traffic information, etc.), and vehicle camera information (e.g., for road images, road traffic signs, and/or the like), in addition to GNSS information (e.g., vehicle location and speed, etc.) to be utilized to enable a modem to more quickly and accurately select a PLMN in a new region/country when a vehicle UE is crossing the region/country border by land. Aspects improve the reliability of border mode determinations for vehicular UEs by incorporating additional information with GNSS fixes. Aspects also improve the performance as well as the accuracy of border mode determinations for vehicular UEs, such as lower threshold distances for border crossing detections, by incorporating vehicle information together with UE cell history, vehicle trip history, and/or road geometry/characteristics information.

As described herein, functions/operations may be performed by a UE that includes a modem and/or a modem application processor (modem AP). It is contemplated that when this description provides for the UE to perform functions/operations, this description also contemplates performance by a modem and/or a modem application processor.

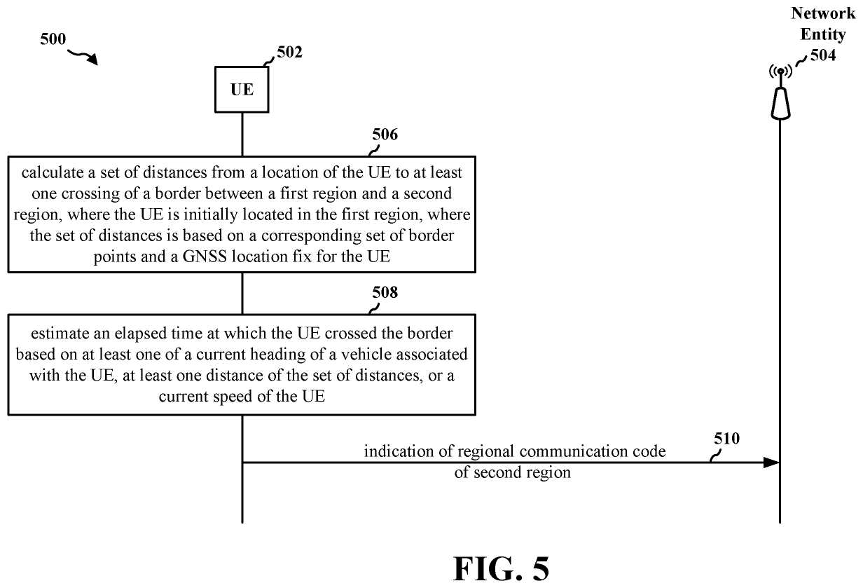

FIG. 5 is a call flow diagram 500 for wireless communications, in various aspects. Call flow diagram 500 illustrates vehicle information aided roaming and PLMN selection in vehicular UEs for border crossings for a wireless device (a UE 502, by way of example) that communicates with a network entity 504 (e.g., a base station such as a gNB or other type of base station, by way of example, as shown, another type of network node, a core network entity, etc.), in various aspects. Aspects described for the network entity 504, and for network nodes/entities herein, generally, may be performed by the network node/entity (e.g., a base station) in aggregated form and/or by one or more components of the network node/entity in disaggregated form. Additionally, or alternatively, the aspects may be performed by the UE 502 autonomously, in addition to, and/or in lieu of, operations of the network entity 504.

In aspects, the UE 502 may be in, or may comprise a vehicle. Aspects may provide for a modem in a UE or a vehicular UE to trigger an indication of new or different region/country (and an associated new regional communication code/MCC) to an upper layer of a wireless communication network for a landline border crossing (e.g., a crossing of a border between two regions) using different sets of vehicle information, such as, but not limited to, a vehicle heading/trajectory, a vehicle speed, a vehicle location, vehicle navigation information, vehicle map information, and/or the like.

In the illustrated aspect, the UE 502 may be configured to calculate (at 506) a set of distances from a location of the UE 502 to at least one crossing of a border between a first region and a second region. In aspects, the UE 502 may be initially located in the first region, and the set of distances may be based on a corresponding set of border points and a GNSS location fix for the UE 502. For instance, the UE 502 may be configured to periodically calculate (e.g., every T_{non-border mode}) the vehicle/UE 502 distance to a number of crossings of a border between two regions as the distance between a last available GNSS fix and a respective border point. In some aspects, the UE 502 may be configured to receive information for the distance to the border crossing from a navigation/map entity (e.g., an ADAS module) over a CAN bus or an Ethernet interface.

The UE 502 may be configured to estimate (at 508) an elapsed time at which the UE 502 crossed the border based on at least one of a current heading of a vehicle associated with the UE 502, (ii) at least one distance of the set of distances, or (iii) a current speed of the UE 502. For instance, the UE 502 may be configured to estimate (at 508) a time(s) (e.g., an elapsed time(s) (T or Telapsed)) to the border crossing using the set of distances calculated (at 506) and a projected vehicle speed with respect to the direction to the border point. In aspects, this may be performed using vehicle heading information from an IMU (e.g., detecting deviations from the direction to the magnetic north pole). The UE 502 may be configured to calculate/determine whether the UE 502/vehicle is approaching, or going away from, the border region using vehicle heading information from the IMU.

In aspects, calculating (at 506) the set of distances and estimating (at 508) the elapsed time may be associated with each other. The UE 502 may be configured to determine when the UE 502/vehicle is within a proximity to a crossing of the border such that the time period/interval for calculating (at 506) the set of distances and estimating (at 508) the elapsed time is adjusted (e.g., reduced). As one example of such a periodicity threshold condition, if T<T_{trigger-border}−T_{offset}, the UE 502 may be configured to lower/reduce the time-interval (e.g., every T_{border mode}, where T_{border mode} <T_{non-border mode}) for calculation (at 506) of the set of distances and estimation (at 508) of the elapsed time T. That is, the periodicity threshold condition may be met when the elapsed time at which the UE 502 crossed the border is less than or equal to a trigger time minus a time offset. In such a configuration, the UE 502 may be configured to calculate (at 506) the set of distances from the location of the UE 502 to the at least one crossing of the border between the first region and the second region by periodically calculating (at 506) the set of distances based on a dynamic periodicity that may be adjusted (e.g., lowered or raised) based on the elapsed time estimated (at 508) at which the UE 502 crossed the border and the periodicity threshold condition. Similarly, the UE 502 may be configured to estimate (at 508) the elapsed time at which the UE 502 crossed the border by estimating (at 508) updated elapsed times at which the UE 502 crossed the border for each performance of periodically calculating (at 506) the set of distances.

The UE 502 may be configured to provide, for the network entity 504 and based on the elapsed time at which the UE 502 crossed the border and a crossing threshold condition, an indication 510 of a regional communication code of the second region associated with roaming of the UE 502 in the second region. For instance, the UE 502 may be configured to provide, for an upper layer of the wireless communication network associated with the network entity 504, the indication 510 of the regional communication code (e.g., an MCC) of the second region associated with roaming of the UE 502 in the second region if (1) (T>T*+T_{offset}), where T* is a threshold for a minimum time past the border crossing and T_{offset} is an offset value to reduce the margin of error, and (2) the UE 502/vehicle is in the new or different region/country, and (3) the UE 502/vehicle is going away from (or not approaching to) the border. That is, when such a condition is met, the UE 502 may be configured to indicate the regional communication code (e.g., an MCC) of the second region associated with roaming of the UE 502 in the second region to an upper layer of the wireless communication network associated with the network entity 504 for PLMN selection and RAT/frequency band scans based on the second region (e.g., new country) band policy.

In some aspects, such as scenarios where the UE 502 has access to road traffic information (e.g., from an ADAS module over a CAN bus or an Ethernet interface), when the UE 502 obtains an indication that the road traffic is heavy in the vehicle path/trajectory, and the UE 502/vehicle is going away from (or not approaching to) the border, the UE 502 may be configured to adjust/reduce the value of the threshold for a minimum time past the border crossing (T*). In other aspects, if the UE 502 fails to select a PLMN or a suitable cell in the second region, the UE 502 may be configured to fall back to a default PLMN search/selection, as is described for the baseline 3GPP scenario.

In aspects, such as the UE 502 being configured to identify that the location of the UE 502 is in the second region based on an updated GNSS location fix, the UE 502 may be configured to provide the indication 510 of the regional communication code of the second region further based on at least one of (i) a latest one of the updated elapsed times being greater than or equal to a minimum time threshold after the elapsed time plus a time offset, (ii) the location of the UE being in the second region, or (iii) the current heading of the vehicle associated with the UE 502. In some aspects, the UE 502 may be configured to provide the indication 510 based on historical information associated with the UE 502, e.g., trip history information of the UE 502/vehicle, map geometry, road geometry, cell history information, and/or the like.

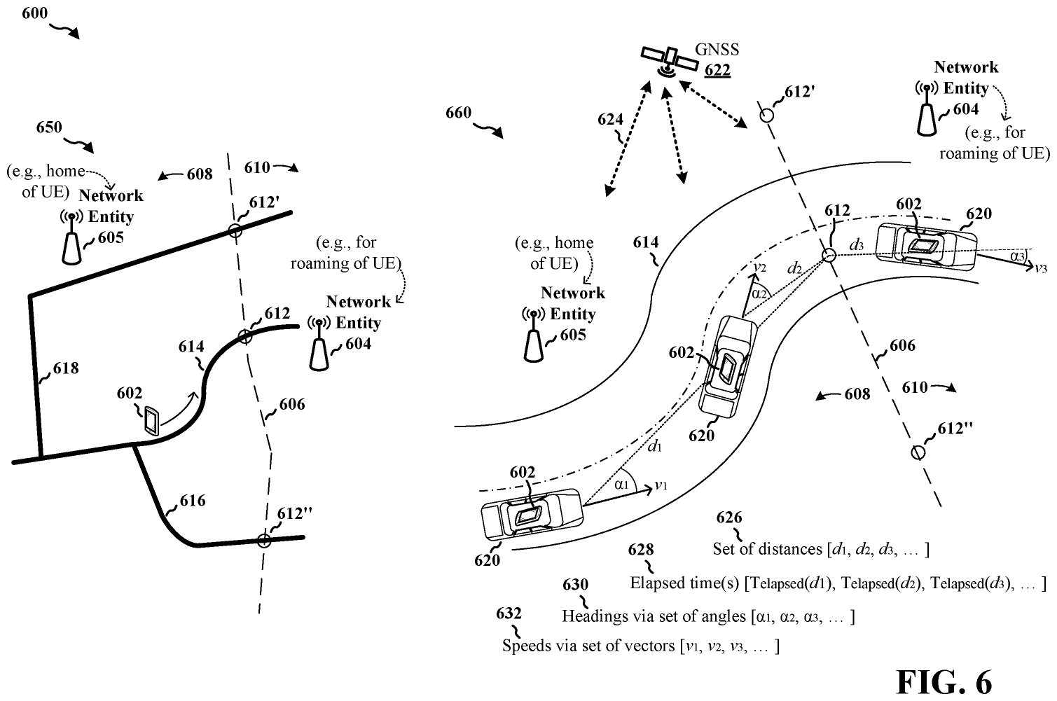

FIG. 6 is a diagram 600 illustrating an example of vehicle information aided roaming and PLMN selection in vehicular UEs for border crossings, in various aspects. Diagram 600 shows a configuration 650 and a configuration 660 in the context of a UE 602, which may be associated with (e.g., may be in and/or may comprise) a vehicle 620, that crosses a border 606 from a first region 608, serviced by a network entity 605 to a second region 610, service by a network entity 604 (e.g., via roaming for the UE 602).

In the configuration 650, the UE may traverse a roadway system, shown by way of example as including a roadway 614, a roadway 616, and a roadway 618, that meet the border 606 in a border region at a border point 612, a border point 612′, a border point 612″, respectively. The UE 602 is shown as traversing the roadway 614 toward the border point 612.

In the configuration 660, a further detailed illustration of the UE 602 traversing the roadway 614 toward the border point 612 is shown. As noted herein, the UE 602 may be configured to obtain, determine, or calculate its location utilizing a set of location fixes 624 via a GNSS 622. In addition to a set of distances 626 (e.g., calculated using the set of location fixes 624 via the GNSS 622, according to aspects, the UE 602 may be configured to utilize different sets of vehicle information, such as, but not limited to, a vehicle heading 630 or trajectory, a vehicle speed, a vehicle location, vehicle navigation information, vehicle map information, geometry of the roadway 614, and/or the like, to determine a crossing threshold condition by which an indication (e.g., the indication 510 in FIG. 5) of a regional communication code of the second region 610 associated with roaming of the UE 602 in the second region 610 is provided to the network entity 604. In aspects, the UE 602 may be configured to estimate at least one elapsed time (T) (e.g., an elapsed time(s) 628) at which the UE 602 crossed the border 606 based on at least one of a heading 630 (e.g., a current heading) of the vehicle 620 associated with the UE 602, at least one distance of the set of distances 626, or a current speed 632 of the UE 602.

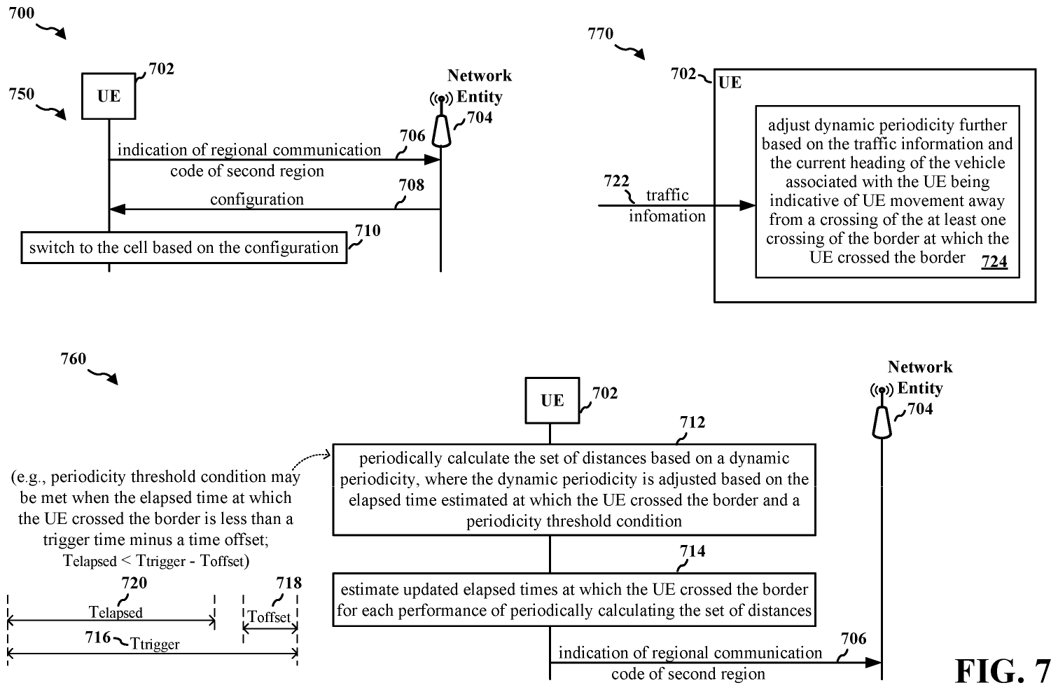

FIG. 7 is a diagram 700 illustrating example configurations for vehicle information aided roaming and PLMN selection in vehicular UEs for border crossings, in various aspects. Diagram 700 shows a configuration 750, a configuration 760, and a configuration 770 in the context of a UE 702 and a network entity 704.

In the configuration 750, the UE 702 may be configured to provide, and the network entity 704 may be configured to receive, based on the elapsed time at which the UE 702 crossed the border and a crossing threshold condition, an indication 706 (e.g., an aspect of the indication 510 in FIG. 5) of a regional communication code of the second region associated with roaming of the UE 702 in the second region. The network entity 704 may be configured to provide, and the UE 702 may be configured to receive, based on the indication 706 of the regional communication code of the second region, a configuration 708 indicative of a switch to a cell associated with the regional communication code of the second region (e.g., a cell associated with the network entity 704). The UE 702 may be configured to switch (at 710) to the cell based on the configuration 708. Subsequently, the UE 702 and the network entity 704 may be configured to communicate with each other based on the switch to the cell.

In the configuration 760, the UE 702 may be configured to periodically calculate (at 712) the set of distances based on a dynamic periodicity, where the dynamic periodicity is adjusted (e.g., lowered) based on the elapsed time 720 estimated at which the UE 702 crossed the border and a periodicity threshold condition. In aspects, the periodicity threshold condition may be met when the elapsed time 720 at which the UE crossed the border is less than a trigger time 716 minus a time offset 718 (e.g., Telapsed<T_{trigger}−T_{offset}). That is, a lower estimated value for the elapsed time 720 may indicate proximity to the border for which more frequent checks may be desired. The UE 702 may be configured to estimate (at 714) updated elapsed times at which the UE 702 crossed the border for each performance of periodically calculating the set of distances. Subsequently, the UE 702 may be configured to provide, and the network entity 704 may be configured to receive, based on the elapsed time at which the UE 702 crossed the border and a crossing threshold condition, an indication 706 (e.g., an aspect of the indication 510 in FIG. 5) of a regional communication code of the second region associated with roaming of the UE 702 in the second region, as noted above for the configuration 750.

Accordingly, the dynamic periodicity may be utilized by the UE 702 to more frequently check for border conditions when in proximity to the border region between a first region and a second region based on the described conditions. Thus, a finer granularity in border checks is appropriately utilized for more accurate and timely detections of border crossings.

In the configuration 770, the UE 702 may be configured to obtain traffic information 722 associated with the vehicle that is associated with the UE 702. In aspects, the traffic information 722 may be obtained from an ADAS module over a CAN bus or an Ethernet interface, and may include, without limitation, an indication of traffic congestion, speeds, accidents, inferences of future conditions, and/or the like. In aspects, the UE 702 may be configured to adjust (at 724) the dynamic periodicity further based on the traffic information 722 and the current heading of the vehicle associated with the UE 702 being indicative of UE movement away from a crossing of the at least one crossing of the border at which the UE 702 crossed the border. For instance, the UE 702 may adjust the dynamic periodicity (e.g., by lowering) based on heavy traffic and UE 702/vehicle movement away from the border.

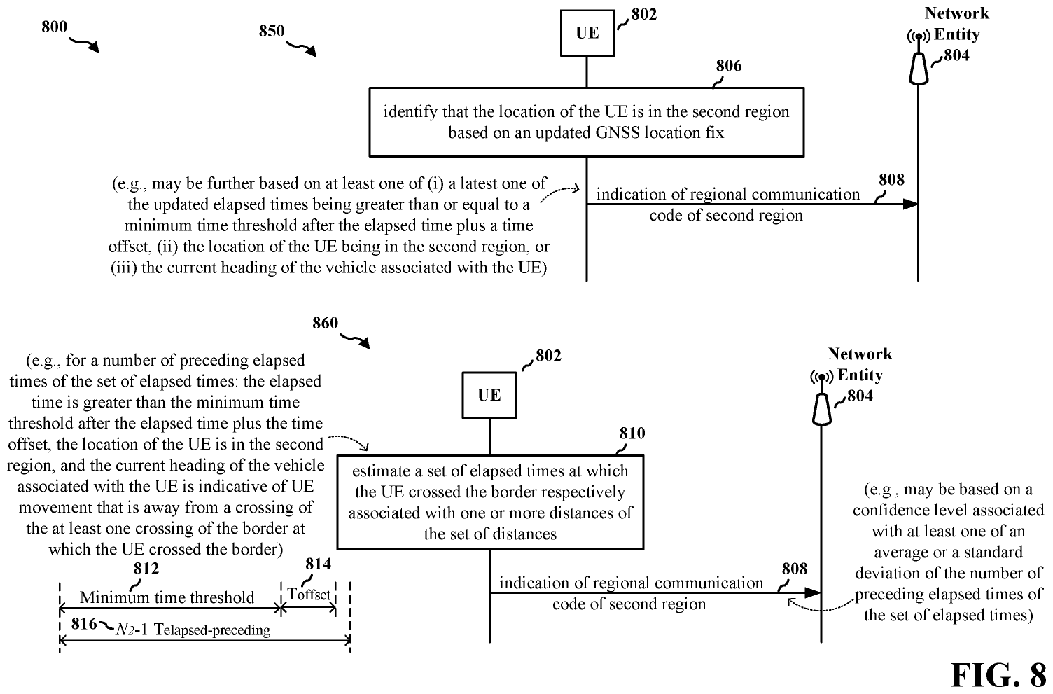

FIG. 8 is a diagram 800 illustrating example configurations for vehicle information aided roaming and PLMN selection in vehicular UEs for border crossings, in various aspects. Diagram 800 shows a configuration 850 and a configuration 860 in the context of a UE 802 and a network entity 804.

In the configuration 850, the UE 802 may be configured to identify (at 806) that the location of the UE 802 is in the second region based on an updated GNSS location fix. For example, based on a recent GNSS location fix, the UE 802 may be configured to identify (at 806) that the border between the first region and the second region has been crossed. Subsequently, the UE 802 may be configured to provide, and the network entity 804 may be configured to receive, an indication 808 (e.g., an aspect of the indication 510 in FIG. 5) of a regional communication code of the second region associated with roaming of the UE 802 in the second region. In such aspects, the provision of the indication 808 may be further based on at least one of (i) a latest one of the updated elapsed times (e.g., that are estimated (at 714), as described for FIG. 7) being greater than or equal to a minimum time threshold 812 after the elapsed time plus a time offset 814, (ii) the location of the UE 802 being in the second region, and/or (iii) the current heading of the vehicle associated with the UE 802.

In the configuration 860, reliability of aspects may be improved by storing the estimated time(s) (T or Telapsed) and performing multiple checks for a border crossing, as noted above, when the UE 802/vehicle is in a proximity of the border and approaching the border (e.g., a landline border crossing). For instance, the UE 802 may be configured to estimate (at 810) a set of elapsed times (e.g., the elapsed time(s) 628 in FIG. 6) at which the UE 802 crossed the border respectively associated with one or more distances of the set of distances (e.g., the set of distances 626 in FIG. 6). In the context of multiple checks for the aspect illustrated in the configuration 860, for the UE 802 to provide the indication 808 to the network entity 804, for a number of preceding elapsed times 816 of the set of elapsed times: the elapsed time is greater than the minimum time threshold 812 after the elapsed time plus the time offset 814, the location of the UE 802 is in the second region, and the current heading of the vehicle associated with the UE 802 is indicative of UE movement that is away from a crossing of the at least one crossing of the border at which the UE 802 crossed the border.

As an example, when (T<T_{trigger}−T_{offset}), the UE 802 (e.g., via a modem) may record/store the estimated T's (e.g., elapsed times) that are estimated/calculated at every T_{border mode} time interval, according to the adjusted (e.g., lowered) dynamic periodicity associated with T_{border mode}. If (T>T*+T_{offset}) and the UE 802/vehicle is in the second region/country and the UE 802/vehicle is going away from the border in the current check and in the N₂-1 previous checks, the indication 808 may be provided. That is, the UE 802, when the multiple checks (e.g., the current and the N₂-1 previous checks) indicate a crossing of the border, may be configured to provide/transmit, and the network entity 804 may be configured to receive, the indication 808 of the regional communication code of the second region associated with roaming of the UE 802 in the second region.

In such aspects, the provision of the indication 808 may be based on a confidence level associated with at least one of an average or a standard deviation of the number of preceding elapsed times 816 of the set of elapsed times. The UE 802 may be configured to track the average and/or the standard deviation of the number of preceding elapsed times 816 of the set of elapsed times (T). As an example, the lower the standard deviation (e.g., lower values of N₁ and/or N₂), the higher the confidence for the UE 802/modem to indicate the new regional communication code (e.g., MCC) to upper layers of the network.

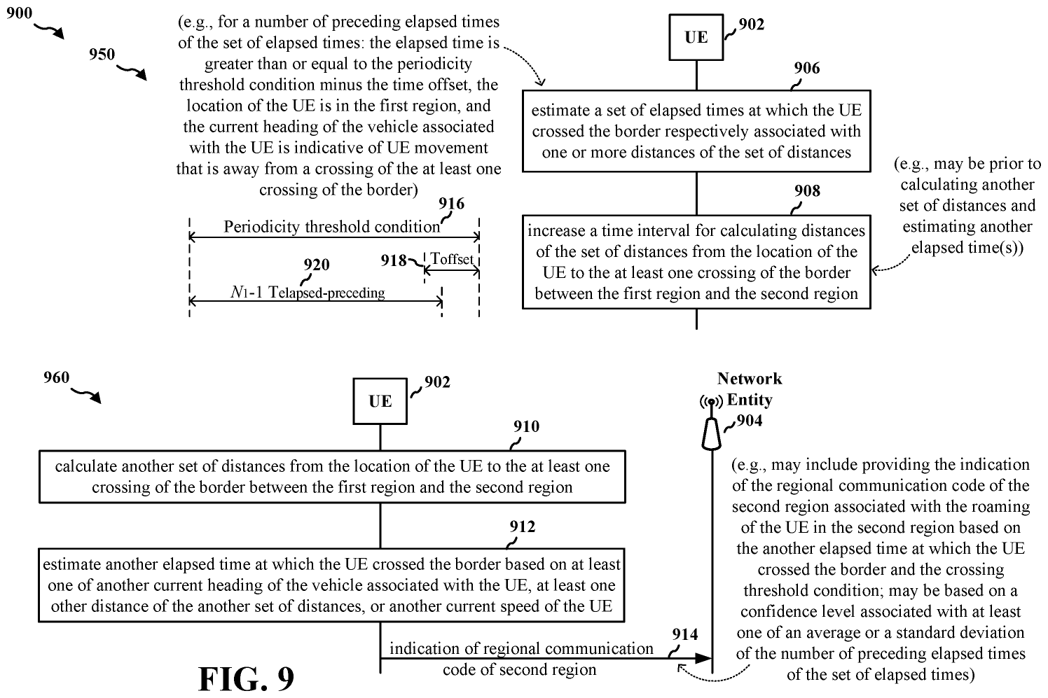

FIG. 9 is a diagram 900 illustrating example configurations for vehicle information aided roaming and PLMN selection in vehicular UEs for border crossings, in various aspects. Diagram 900 shows a configuration 950 and a configuration 960 in the context of a UE 902 and a network entity 904.

In the configuration 950, reliability of aspects may be improved by storing the estimated time(s) (T or Telapsed) and performing multiple checks for a border crossing, as noted above, when the UE 802/vehicle is in a proximity of the border and approaching the border (e.g., a landline border crossing). For instance, the UE 902 may be configured to estimate (at 906) a set of elapsed times (e.g., the elapsed time(s) 628 in FIG. 6) at which the UE 902 crossed the border respectively associated with one or more distances of the set of distances (e.g., the set of distances 626 in FIG. 6). In the context of multiple checks for the aspect illustrated in the configuration 950, and in contrast to the configuration 860 in FIG. 8, an indication (e.g., the indication 808 in FIG. 8) may not be sent if the border condition is not met. Conversely, the UE 902 may be configured to revert from its mode of operation for border proximity (e.g., a lowered value for dynamic periodicity associated with T_{border mode} back to a periodicity T_{non-border mode}. That is, in contrast to the configuration 860 in FIG. 8, when the UE 902 estimates (at 906) the set of elapsed times (e.g., the elapsed time(s) 628 in FIG. 6) at which the UE 902 crossed the border respectively associated with one or more distances of the set of distances (e.g., the set of distances 626 in FIG. 6), an indication (e.g., the indication 808 in FIG. 8) of a regional communication code of the second region associated with roaming of the UE in the second region may not be sent if the border condition is not met, and the UE 902 may revert to the periodicity T_{non-border mode}.

For instance, if over the number of preceding elapsed times 920 of the set of elapsed times: the elapsed time is greater than or equal to the periodicity threshold condition 916 minus the time offset 918, the location of the UE 902 is in the first region, and the current heading of the vehicle associated with the UE 902 is indicative of UE movement that is away from a crossing of the at least one crossing of the border, the indication may not be sent and operation for outside of border proximity may be undertaken.

Accordingly, the UE 902 may be configured to increase (at 908) a time interval (e.g., periodicity) for calculating distances of the set of distances from the location of the UE 902 to the at least one crossing of the border between the first region and the second region. As an example, if (T≥T_{trigger}−T_{offset}) or if the UE 902/vehicle is going away from the border, and the UE 902/vehicle is in the first region/country (e.g., the border has not been crossed) during the current check and in N₁-1 previous checks, the UE 802/modem may be configured to flush the recorded/stored estimated T's and to adjust (e.g., increase) the time interval, based on dynamic periodicity, for calculating the set of distances and estimating the elapsed time T, to T_{non-border mode}. In aspects, when the UE 902 increases (at 908) the time interval (for calculating distances of the set of distances from the location of the UE 902 to the at least one crossing of the border between the first region and the second region, such a performance may occur prior to calculating another set of distances and estimating another elapsed time(s) for a determination of crossing the border from the first region to the second region, as described below with respect to the configuration 960.

In aspects, performance of operations in the configuration 960 may follow the operations described in the configuration 950. In the configuration 960, the UE 902 may be configured to calculate (at 910) another set of distances from the location of the UE 902 to the at least one crossing of the border between the first region and the second region. This may be a further aspect of a UE being configured to calculate the set of distances, as described above (e.g., at 506 in FIG. 5). The UE 902 may also be configured to estimate (at 912) another elapsed time at which the UE 902 crossed the border based on at least one of another current heading of the vehicle associated with the UE 902, at least one other distance of the another set of distances, and/or another current speed of the UE 902. This may be a further aspect of a UE being configured to estimate the elapsed time, as described above (e.g., at 508 in FIG. 5).

The UE 902 may be configured to provide, based on the another elapsed time at which the UE 902 crossed the border and the crossing threshold condition, an indication 914 of the regional communication code of the second region associated with roaming of the UE 902 in the second region. That is, providing such an indication may include providing the indication 914 of the regional communication code of the second region associated with the roaming of the UE 902 in the second region based on the another elapsed time at which the UE 902 crossed the border and the crossing threshold condition, and/or may be based on a confidence level associated with at least one of an average or a standard deviation of the number of preceding elapsed times 920 of the set of elapsed times.

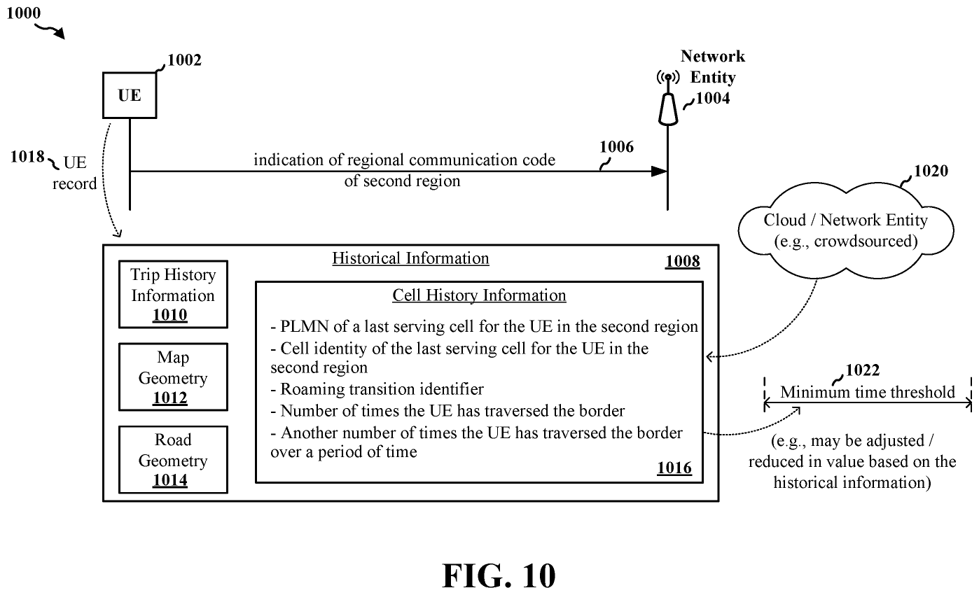

FIG. 10 is a diagram 1000 illustrating example configurations for vehicle information aided roaming and PLMN selection in vehicular UEs for border crossings, in various aspects. Diagram 1000 is shown in the context of a UE 1002 and a network entity 1004 for utilization of historical information 1008 to determine crossings of a border between a first region/country and a second region/country.

The UE 1002 may be configured to provide/transmit, and the network entity 1004 may be configured to receive, an indication 1006 of a regional communication code of the second region associated with roaming of the UE 1002 in the second region, as described herein. In aspects, the provision of the indication 1006 may be based on the historical information 1008. For example, the regional communication code indicated by the indication 1006 may be selected by the UE 1002 based on the historical information 1008. Such aspects may enable a faster PLMN selection when the UE 1002 crosses a border from a first region to a second region. The historical information 1008 may include, but is not limited to, trip history information 1010 of the UE 1002/vehicle, map geometry 1012, road geometry 1014, and cell history information 1016 (e.g., in or from a database thereof).

In aspects, the cell history information 1016 may be comprised in a UE record 1018 obtained/maintained by the UE 1002 and/or may be obtained by the UE 1002 from a cloud-/network-based entity 1020 (e.g., via crowdsourcing). The cell history information 1016 associated with the UE 1002 may include, without limitation, at least one of a PLMN of a last serving cell for the UE 1002 in the second region (e.g., associated with the network entity 1004), a cell identity of the last serving cell for the UE 1002 in the second region (e.g., associated with the network entity 1004), a roaming transition identifier (e.g., a type of roaming transition such as Home to Roam, Roam to Home, Roam to Roam), a number of times the UE 1002 has traversed the border, or another number of times the UE 1002 has traversed the border over a period of time.

As noted above, the use of historical information 1008 may enable a faster PLMN selection when the UE 1002 crosses a border from a first region to a second region. In aspects, on-device learning may be performed by the UE 1002. For example, while crossing a border, the UE 1002 may be configured to record: (i) cell global identifiers (CGIs), e.g., PLMNs and cell identities, of the last serving cells (e.g., such as for cases of carrier aggregation (CA) associated with a primary component carriers (PCCs) and/or a secondary component carrier (SCCs); for cases of dual connectivity (DC) for SpCells and SCells) before the UE 1002 camps on a cell belonging to a PLMN of a different region/country, (ii) a type(s) of roaming transitions (e.g., Home to Roam, Roam to Home, Roam to Roam), etc. Furthermore, the UE 1002 may track the number of times (e.g., as a parameter/variable “count_border”) such an event has happened or happens over the past number ‘M’ days. Such information may be stored in a database for the cell history information 1016. Some aspects provide for utilizing a cloud-/network-based entity 1020 (e.g., via crowdsourcing) by which the cell history information 1016 of the UE 1002 for this purpose may be provided using crowdsourced data from a cloud server.

As one example, using the historical information 1008 for vehicle trips (e.g., a driver lives in a first city in a first region/country and drives to a second city in a second region/country for work every day, crossing the border (e.g., the land line border) therebetween X times over the past M days), the UE 1002 may be configured to adjust (e.g., lower) the for the minimum time threshold 1022 (T*) past the border crossing, described herein, when the UE 1002 camps/redirects to a CGI belonging to the cell history information in the database and where (X≥Thresh₁) or where the value of ‘count_border) satisfies (count_border≥Thresh₂), where Thresh₁ and Thresh₂ are configured/preconfigured values stored at the UE 1002 (e.g., in a modem configuration file). In other examples, the UE 1002 may be configured to lower the events of false border region detections and further improve the reliability of the aspects herein, with the same T* minimum time threshold 1022 past the border crossing by using the cell history information 1016 database for the UE 1002 and the trip history information 1010 of the UE 1002/vehicle.

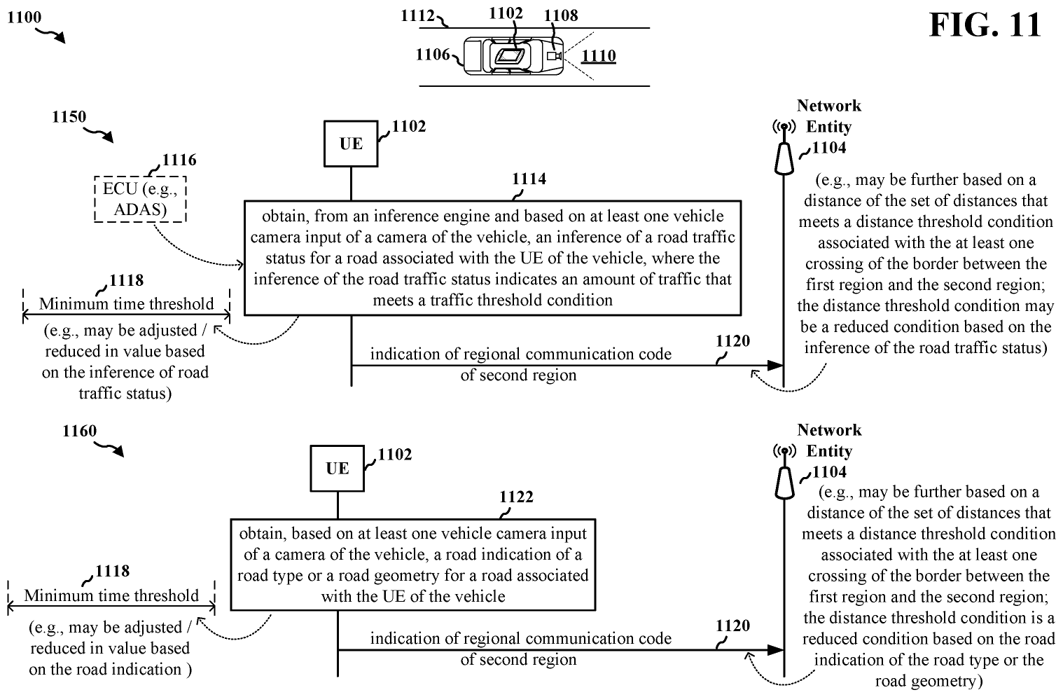

FIG. 11 is a diagram 1100 illustrating example configurations for vehicle information aided roaming and PLMN selection in vehicular UEs for border crossings, in various aspects. Diagram 1100 shows a configuration 1150 and a configuration 1160 in the context of a UE 1102 and a network entity 1104. The UE 1102 may be in, or may comprise, a vehicle 1106 that includes at least one camera 1108 configured to produce road images 1110 (or other sensory captures) as vehicle camera inputs associated with a roadway 1112. Aspects may enable a faster PLMN selection when the UE 1102 crosses a border from a first region to a second region by utilizing road images captured by vehicle cameras (e.g., the at least one camera 1108).

In the configuration 1150, the UE 1102 may be configured to obtain (at 1114), from an inference engine and based on at least one of the road images 1110 (or other sensory captures) as vehicle camera inputs of at least one camera 1108 of the vehicle 1106, an inference of a road traffic status for the roadway 1112 associated with the UE 1102 of the vehicle 1106. In aspects, the inference of the road traffic status may indicate an amount of traffic that meets a traffic threshold condition. The inference engine may be included in the UE 1102/modem, or may be included in an ECU 1116 of the vehicle 1106 (e.g., an ADAS). In aspects, a minimum time threshold 1118 after the elapsed time, as described herein, may be a reduced value based on the inference of the road traffic status. The UE 1102 may be configured to provide/transmit, and the network entity 1104 may be configured to receive, an indication 1120 of a regional communication code of the second region associated with roaming of the UE 1102 in the second region, as described herein. In aspects, the indication 1120 may be further based on a distance of the set of distances that meets a distance threshold condition associated with the at least one crossing of the border between the first region and the second region. The distance threshold condition may be a reduced condition based on the inference of the road traffic status.

As an example, when the UE 1102/vehicle 1106 is in the new region/country, the UE 1102/modem AP may be configured to infer the traffic/road congestion status of the roadway 1112 using the road images 1110 from the at least one vehicle camera 1108 and to indicate to the modem when the traffic is inferred to be heavy (e.g., Heavy_traffic=True) in the trajectory/path of the UE 1102/vehicle 1106. The inference engine may be alternatively implemented in another ECU (e.g., ADAS) and the Heavy_traffic=True indication may be sent to the modem via a CAN bus or

Ethernet interface. If (Heavy_traffic=True) and the UE 1102/vehicle 1106 heading from an IMU indicates that the UE 1102/vehicle 1106 is going away from (or not approaching to) a crossing of a border between a first and second region, the UE 1102/modem may be configured to adjust/lower the minimum time threshold 1118 after the elapsed time (e.g., T*) (or alternatively lower a minimum distance threshold from the border point crossing to the UE 1102/vehicle 1106) to indicate a detection of being in the second region/country (e.g., the indication 1120 of the regional communication code/MCC) to the upper layer(s) of the network in the second region/country.

In the configuration 1160, the UE 1102 may be configured to obtain (at 1122), based on at least one vehicle camera input (e.g., the road images 1110) of the at least one camera 1108 of the vehicle 1106, a road indication of a road type or a road geometry for a road (e.g., the roadway 1112) associated with the UE 1102 of the vehicle 1106. In aspects, the minimum time threshold 1118 after the elapsed time, as described herein, may be adjusted (e.g., as a reduced value) based on the road indication. The UE 1102 may be configured to provide/transmit, and the network entity 1104 may be configured to receive, the indication 1120 of the regional communication code of the second region associated with roaming of the UE 1102 in the second region for the aspect shown in the configuration 1160, as described herein. In aspects, the indication 1120 may be further based on a distance of the set of distances that meets a distance threshold condition associated with the at least one crossing of the border between the first region and the second region. The distance threshold condition may be a reduced condition based on the road indication of the road type or the road geometry.

As an example, when the UE 1102/vehicle 1106 is in the new region/country, the UE 1102/modem AP may be configured to determine/identify the road geometry/type using the road images 1110 as inputs from the at least one camera 1108 of the vehicle 1106 and to send this information to the modem. Road geometry (e.g., sharp curves or turns) along with vehicle heading and vehicle speed information may be utilized to adjust/lower the minimum time threshold 1118 after the elapsed time (e.g., T*) (or alternatively lower a minimum distance threshold from the border point crossing to the UE 1102/vehicle 1106) to indicate a detection of being in the second region/country (e.g., the indication 1120 of the regional communication code/MCC) to the upper layer(s) of the network in the second region/country.

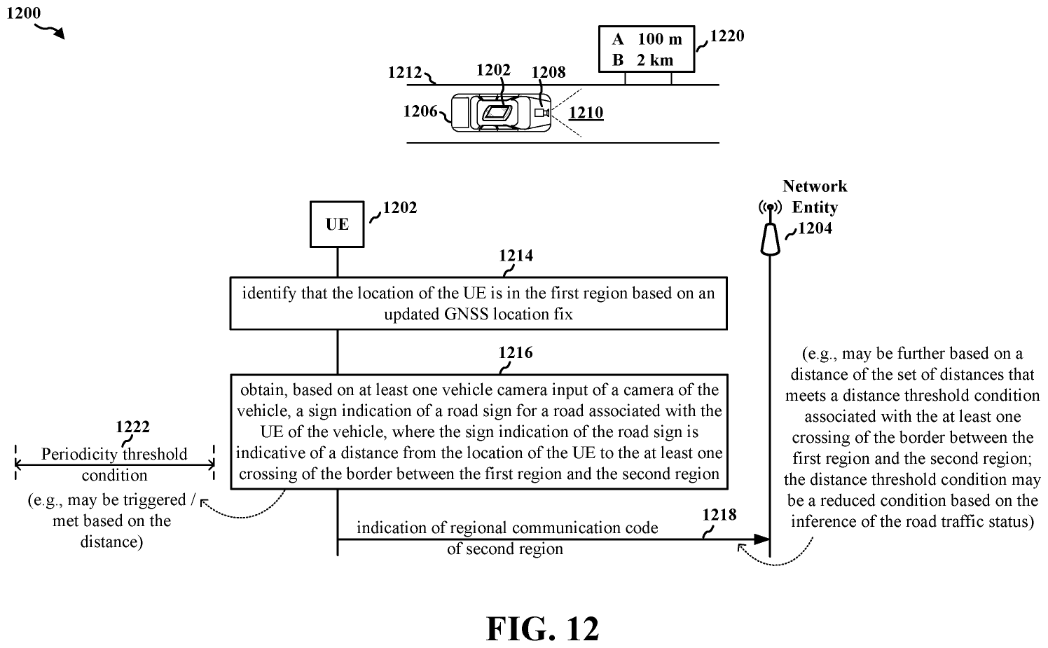

FIG. 12 is a diagram 1200 illustrating example configurations for vehicle information aided roaming and PLMN selection in vehicular UEs for border crossings, in various aspects. Diagram 1200 shows a configuration in the context of a UE 1202 and a network entity 1204. The UE 1202 may be in, or may comprise, a vehicle 1206 that includes at least one camera 1208 configured to produce road images 1210 (or other sensory captures) as vehicle camera inputs associated with a roadway 1212, such as of a road sign 1220 (or more than one of road sign 1220), or a traffic sign. Aspects may enable a faster PLMN selection when the UE 1202 crosses a border from a first region to a second region by utilizing images of the road sign 1220 captured by vehicle cameras (e.g., the at least one camera 1208).

As shown in diagram 1200, the UE 1202 may be configured to identify (at 1214) that the location of the UE 1202 is in the first region based on an updated GNSS location fix. That is, the UE 1202/vehicle 1206 may not yet have crossed the border into the second region. The UE 1202 may be configured to obtain (at 1216), based on at least one vehicle camera input (e.g., road images 1210) of the at least one camera 1208 of the vehicle 1206, a sign indication of the road sign 1220 for the roadway 1212 associated with the UE 1202 of the vehicle 1206. The sign indication of the road sign 1220 may be indicative of a distance from the location of the UE 1202 to the at least one crossing of the border between the first region and the second region. In aspects, the distance from the location of the UE 1202 to the at least one crossing of the border may be utilized by the UE 1202 to provide an indication 1218. Subsequent to a crossing of the border, the UE 1202 may be configured to provide/transmit, and the network entity 1204 may be configured to receive, the indication 1218 of a regional communication code of the second region associated with roaming of the UE 1202 in the second region, as described herein. In aspects, the indication 1218 may be further based on a distance of the set of distances that meets a distance threshold condition associated with the at least one crossing of the border between the first region and the second region. The distance threshold condition may be a reduced condition based on the inference of the road traffic status.

In aspects, the UE 1202 may be configured to estimate the elapsed time at which the UE 1202 crossed the border, as described herein, further based on the distance from the location of the UE 1202 to the at least one crossing of the border between the first region and the second region. In aspects, the UE 1202 may be configured to periodically calculate the set of distances based on the dynamic periodicity, as described herein, further based on the distance from the location of the UE 1202 to the at least one crossing of the border between the first region and the second region. For instance, the UE 1202 may operate in its border proximity mode with a dynamic periodicity associated with T_{border mode}, as described herein, based on the distance from the location of the UE 1202 to the at least one crossing of the border between the first region and the second region.

As an example, when the UE 1202/vehicle 1206 is in the first region/country, the UE 1202/modem AP may be configured to process road images 1210 of the road sign 1220 captured by the at least one vehicle camera 1208 and, if available, to send the distance from the UE 1202 to the border (e.g., as a dist_{border}) to the modem. The UE 1202/modem may be configured to estimate, as described herein, the elapsed time (T) at which the UE crossed the border (e.g., a time to the landline border crossing) using the value of dist_{border} and the projected vehicle speed with respect to the direction to the border point crossing. In aspects, the UE 1202/modem may be configured to utilize the value of dist_{border} instead of distances between the last available GNSS fix and the border point crossing. In some aspects, the UE 1202/modem may be configured to utilize the value of dist_{border} to adjust/lower the time-interval to T_{border mode} (e.g., from T_{non-border mode} for calculation of the set of distances and/or estimation of the elapsed time (T) at which the UE crossed the border if (T<T_{trigger-border}−T_{offset}) and (dist_{border} <Thr_{dist}), where Thr_{dist} is a configured minimum threshold distance to the border.

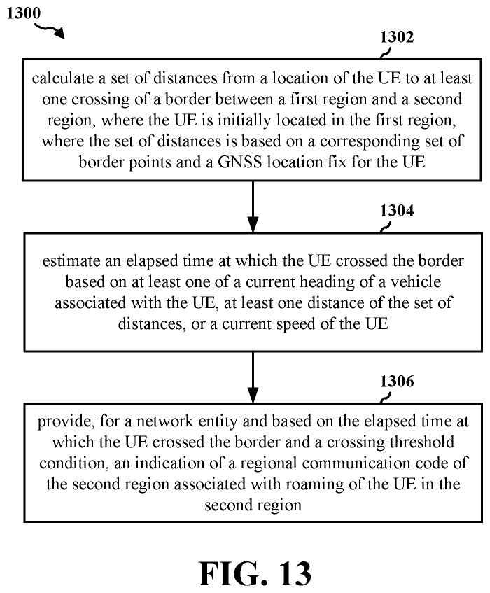

FIG. 13 is a flowchart 1300 of a method of wireless communication. The method may be performed by a UE (e.g., the UE 104, 502, 602, 702, 802, 902, 1002, 1102, 1202; the apparatus 1404). In some aspects, the method may include aspects described in connection with the communication flow in FIG. 6 and/or aspects described in FIGS. 6-12. The method may be for vehicle information aided roaming and PLMN selection in vehicular UEs for border crossings in which a UE may utilize GNSS fixes to prompt a modem to trigger an indication of a new regional communication code to an upper network layer(s) for scanning RATs/frequency bands (e.g., full/limited) based on the new region band policy when the UE is further than a given distance inside the different/new region, and may utilize available vehicle sensor information, navigation information, and vehicle camera information, in addition to GNSS information to enable a modem to more quickly and accurately select a PLMN in a new region when a vehicle UE is crossing the region border by land.

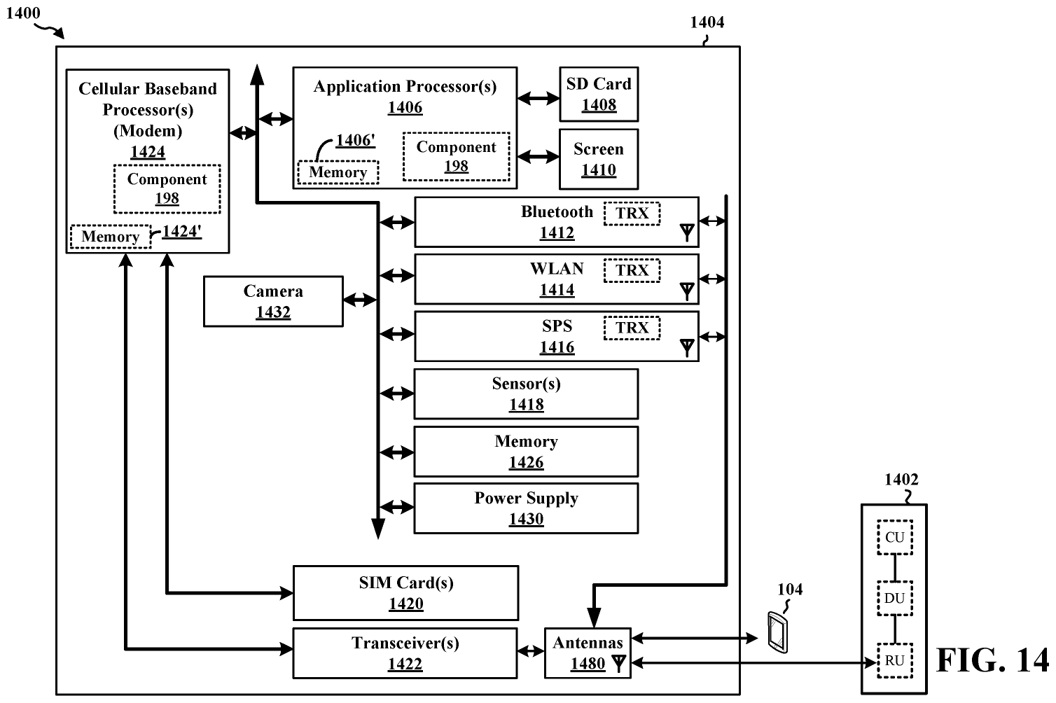

At 1302, the UE calculates a set of distances from a location of the UE to at least one crossing of a border between a first region and a second region, where the UE is initially located in the first region, where the set of distances is based on a corresponding set of border points and a GNSS location fix for the UE. As an example, the calculation may be performed by one or more of the component 198, the transceiver(s) 1422, and/or the antenna 1480 in FIG. 14. FIG. 5 illustrates, in the context of FIGS. 6-12, an example of the UE 502 calculating such a set of distances.

The UE 502 may be in, or may comprise a vehicle (e.g., 620 in FIG. 6; 1106 in FIG. 11; 1206 in FIG. 12). Aspects may provide for a modem in a UE or a vehicular UE to trigger an indication 510 of new or different region (e.g., 608, 610 in FIG. 6)/country (and an associated new regional communication code/MCC) to an upper layer of a wireless communication network for a landline border (e.g., 606 in FIG. 6) crossing (e.g., 612, 612′, 612″ in FIG. 6) (e.g., a crossing of a border between two regions (e.g., 608, 610 in FIG. 6)) using different sets of vehicle information, such as, but not limited to, a vehicle heading/trajectory (e.g., 630 in FIG. 6), a vehicle speed (e.g., 632 in FIG. 6), a vehicle location (e.g., 624 in FIG. 6), vehicle navigation information, vehicle map information, and/or the like.

The UE 502 may be configured to calculate (at 506) (e.g., 712 in FIG. 7; 910 in FIG. 9) a set of distances (e.g., 626 in FIG. 6) from a location (e.g., 624 in FIG. 6) of the UE 502 to at least one crossing (e.g., 612, 612′, 612″ in FIG. 6) of a border (e.g., 606 in FIG. 6) between a first region and a second region (e.g., 608, 610 in FIG. 6). In aspects, the UE 502 may be initially located in the first region (e.g., 608 in FIG. 6), and the set of distances (e.g., 626 in FIG. 6) may be based on a corresponding set of border points (e.g., 612, 612′, 612″ in FIG. 6) and a GNSS (e.g., 622 in FIG. 6) location fix (e.g., 624 in FIG. 6) for the UE 502. For instance, the UE 502 may be configured to periodically calculate (e.g., every T_{non-border mode}) the vehicle (e.g., 620 in FIG. 6; 1106 in FIG. 11; 1206 in FIG. 12)/UE 502 distance to a number of crossings (e.g., 612, 612′, 612″ in FIG. 6) of a border (e.g., 606 in FIG. 6) between two regions (e.g., 608, 610 in FIG. 6) as the distance (e.g., 626 in FIG. 6) between a last available GNSS (e.g., 622 in FIG. 6) location fix (e.g., 624 in FIG. 6) and a respective border point (e.g., 612, 612′, 612″ in FIG. 6). In some aspects, the UE 502 may be configured to receive information for the distance (e.g., 626 in FIG. 6) to the border (e.g., 606 in FIG. 6) crossing (e.g., 612, 612′, 612″ in FIG. 6) from a navigation/map entity (e.g., an ADAS module) over a CAN bus or an Ethernet interface.

At 1304, the UE estimates an elapsed time at which the UE crossed the border based on at least one of a current heading (e.g., 630 in FIG. 6) of a vehicle associated with the UE, at least one distance of the set of distances, or a current speed of the UE. As an example, the estimation may be performed by one or more of the component 198, the transceiver(s) 1422, and/or the antenna 1480 in FIG. 14. FIG. 5 illustrates, in the context of FIGS. 6-12, an example of the UE 502 estimating such an elapsed time.

The UE 502 may be configured to estimate (at 508) (e.g., 714 in FIG. 7; 810 in FIG. 8; 906, 910 in FIG. 9) an elapsed time (e.g., 628 in FIG. 6; 720 in FIG. 7; 816 in FIG. 8; 920 in FIG. 9) at which the UE 502 crossed the border (e.g., 606 in FIG. 6) based on at least one of a current heading (e.g., 630 in FIG. 6) of a vehicle (e.g., 620 in FIG. 6; 1106 in FIG. 11; 1206 in FIG. 12) associated with the UE 502, (ii) at least one distance of the set of distances (e.g., 626 in FIG. 6), or (iii) a current speed (e.g., 632 in FIG. 6) of the UE 502. For instance, the UE 502 may be configured to estimate (at 508) (e.g., 714 in FIG. 7; 810 in FIG. 8; 906, 910 in FIG. 9) a time(s) (e.g., an elapsed time(s) (T or Telapsed)) (e.g., 628 in FIG. 6; 720 in FIG. 7; 816 in FIG. 8; 920 in FIG. 9) to the border (e.g., 606 in FIG. 6) crossing (e.g., 612, 612′, 612″ in FIG. 6) using the set of distances (e.g., 626 in FIG. 6) calculated (at 506) and a projected vehicle speed (e.g., 632 in FIG. 6) with respect to the direction to the border point (e.g., 612, 612′, 612″ in FIG. 6). In aspects, this may be performed using vehicle heading information (e.g., 630 in FIG. 6) from an IMU (e.g., detecting deviations from the direction to the magnetic north pole, such as in units of 0.0125 degrees for vehicular UEs equipped with C-V2X and in units of 2 degrees for non-V2X vehicular UEs). The UE 502 may be configured to calculate/determine whether the UE 502/vehicle (e.g., 620 in FIG. 6; 1106 in FIG. 11; 1206 in FIG. 12) is approaching, or going away from, the border (e.g., 606 in FIG. 6) region using vehicle heading information (e.g., 630 in FIG. 6) from the IMU.

In aspects, calculating (at 506) (e.g., 712 in FIG. 7; 910 in FIG. 9) the set of distances (e.g., 626 in FIG. 6) and estimating (at 508) (e.g., 714 in FIG. 7; 810 in FIG. 8; 906, 910 in FIG. 9) the elapsed time (e.g., 628 in FIG. 6; 720 in FIG. 7; 816 in FIG. 8; 920 in FIG. 9) may be associated with each other. The UE 502 may be configured to determine when the UE 502/vehicle (e.g., 620 in FIG. 6; 1106 in FIG. 11; 1206 in FIG. 12) is within a proximity to a crossing (e.g., 612, 612′, 612″ in FIG. 6) of the border (e.g., 606 in FIG. 6) such that the time period/interval for calculating (at 506) (e.g., 712 in FIG. 7; 910 in FIG. 9) the set of distances (e.g., 626 in FIG. 6) and estimating (at 508) (e.g., 714 in FIG. 7; 810 in FIG. 8; 906, 910 in FIG. 9) the elapsed time (e.g., 628 in FIG. 6; 720 in FIG. 7; 816 in FIG. 8; 920 in FIG. 9) is adjusted (e.g., reduced). As one example of such a periodicity threshold condition (e.g., 716 in FIG. 7; 916 in FIG. 9; 1222 in FIG. 12), if T<T_{trigger-border}−T_{offset}, the UE 502 may be configured to lower/reduce the time-interval (e.g., every T_{border mode}, where T_{border mode} <T_{non-border mode}) for calculation (at 506) (e.g., 712 in FIG. 7; 910 in FIG. 9) of the set of distances (e.g., 626 in FIG. 6) and estimation (at 508) (e.g., 714 in FIG. 7; 810 in FIG. 8; 906, 910 in FIG. 9) of the elapsed time T (e.g., 628 in FIG. 6; 720 in FIG. 7; 816 in FIG. 8; 920 in FIG. 9). That is, the periodicity threshold condition (e.g., 716 in FIG. 7; 916 in FIG. 9; 1222 in FIG. 12) may be met when the elapsed time (e.g., 628 in FIG. 6; 720 in FIG. 7; 816 in FIG. 8; 920 in FIG. 9) at which the UE 502 crossed the border (e.g., 606 in FIG. 6) is less than or equal to a trigger time (e.g., 716 in FIG. 7) minus a time offset (e.g., 718 in FIG. 7; 814 in FIG. 8; 918 in FIG. 9). In such a configuration, the UE 502 may be configured to calculate (at 506) (e.g., 712 in FIG. 7; 910 in FIG. 9) the set of distances (e.g., 626 in FIG. 6) from the location (e.g., 624 in FIG. 6) of the UE 502 to the at least one crossing (e.g., 612, 612′, 612′″ in FIG. 6) of the border (e.g., 606 in FIG. 6) between the first region and the second region (e.g., 608, 610 in FIG. 6) by periodically calculating (at 506) (e.g., 712 in FIG. 7; 910 in FIG. 9) the set of distances (e.g., 626 in FIG. 6) based on a dynamic periodicity that may be adjusted (e.g., lowered or raised) based on the elapsed time (e.g., 628 in FIG. 6; 720 in FIG. 7; 816 in FIG. 8; 920 in FIG. 9) estimated (at 508) (e.g., 714 in FIG. 7; 810 in FIG. 8; 906, 910 in FIG. 9) at which the UE 502 crossed the border (e.g., 606 in FIG. 6) and the periodicity threshold condition (e.g., 716 in FIG. 7; 916 in FIG. 9; 1222 in FIG. 12). Similarly, the UE 502 may be configured to estimate (at 508) (e.g., 714 in FIG. 7; 810 in FIG. 8; 906, 910 in FIG. 9) the elapsed time (e.g., 628 in FIG. 6; 720 in FIG. 7; 816 in FIG. 8; 920 in FIG. 9) at which the UE 502 crossed the border (e.g., 606 in FIG. 6) by estimating (at 508) (e.g., 714 in FIG. 7; 810 in FIG. 8; 906, 910 in FIG. 9) updated elapsed times (e.g., 628 in FIG. 6; 720 in FIG. 7; 816 in FIG. 8; 920 in FIG. 9) at which the UE 502 crossed the border (e.g., 606 in FIG. 6) for each performance of periodically calculating (at 506) (e.g., 712 in FIG. 7; 910 in FIG. 9) the set of distances (e.g., 626 in FIG. 6).

At 1306, the UE provides, for a network entity and based on the elapsed time (e.g., 628 in FIG. 6; 816 in FIG. 8; 920 in FIG. 9) at which the UE crossed the border and a crossing threshold condition, an indication of a regional communication code of the second region associated with roaming of the UE in the second region. As an example, the provision/transmission may be performed by one or more of the component 198, the transceiver(s) 1422, and/or the antenna 1480 in FIG. 14. FIG. 5 illustrates, in the context of FIGS. 6-12, an example of the UE 502 providing/transmitting such an indication to a network entity 504.

The UE 502 may be configured to provide, for the network entity 504 and based on the elapsed time (e.g., 628 in FIG. 6; 720 in FIG. 7; 816 in FIG. 8; 920 in FIG. 9) at which the UE 502 crossed the border (e.g., 606 in FIG. 6) and a crossing threshold condition, an indication 510 (e.g., 706 in FIG. 7; 808 in FIG. 8; 914 in FIG. 9; 1006 in FIG. 10; 1120 in FIG. 11; 1218 in FIG. 12) of a regional communication code of the second region (e.g., 610 in FIG. 6) associated with roaming of the UE 502 in the second region (e.g., 610 in FIG. 6). For instance, the UE 502 may be configured to provide, for an upper layer of the wireless communication network associated with the network entity 504, the indication 510 (e.g., 706 in FIG. 7; 808 in FIG. 8; 914 in FIG. 9; 1006 in FIG. 10; 1120 in FIG. 11; 1218 in FIG. 12) of the regional communication code (e.g., an MCC) of the second region (e.g., 610 in FIG. 6) associated with roaming of the UE 502 in the second region (e.g., 610 in FIG. 6) if (1) (T>T*+T_{offset}), where T* is a threshold for a minimum time past the border (e.g., 606 in FIG. 6) crossing (e.g., 612, 612′, 612″ in FIG. 6) and T_{offset} is an offset value to reduce the margin of error, and (2) the UE 502/vehicle (e.g., 620 in FIG. 6; 1106 in FIG. 11; 1206 in FIG. 12) is in the new or different region (e.g., 608, 610 in FIG. 6)/country, and (3) the UE 502/vehicle (e.g., 620 in FIG. 6; 1106 in FIG. 11; 1206 in FIG. 12) is going away from (or not approaching to) the border (e.g., 606 in FIG. 6). That is, when such a condition is met, the UE 502 may be configured to indicate the regional communication code (e.g., an MCC) of the second region (e.g., 610 in FIG. 6) associated with roaming of the UE 502 in the second region (e.g., 610 in FIG. 6) to an upper layer of the wireless communication network associated with the network entity 504 for PLMN selection and RAT/frequency band scans based on the second region (e.g., 610 in FIG. 6) (e.g., new country) band policy.

In some aspects, such as scenarios where the UE 502 has access to road traffic information (e.g., 722 in FIG. 7) (e.g., from an ADAS module over a CAN bus or an Ethernet interface), when the UE 502 obtains an indication that the road traffic is heavy in the vehicle path/trajectory (e.g., 630 in FIG. 6), and the UE 502/vehicle (e.g., 620 in FIG. 6; 1106 in FIG. 11; 1206 in FIG. 12) is going away from (or not approaching to) the border (e.g., 606 in FIG. 6), the UE 502 may be configured to adjust/reduce the value of threshold for a minimum time (T*) (e.g., 812 in FIG. 8; 1022 in FIG. 10; 1118 in FIG. 11) past the border crossing (e.g., 612, 612′, 612″ in FIG. 6). In other aspects, if the UE 502 fails to select a PLMN or a suitable cell in the second region (e.g., 610 in FIG. 6), the UE 502 may be configured to fall back to a default PLMN search/selection, as is described for the baseline 3GPP scenario.

In aspects, such as the UE 502 being configured to identify that the location (e.g., 624 in FIG. 6) of the UE 502 is in the second region (e.g., 610 in FIG. 6) based on an updated GNSS (e.g., 622 in FIG. 6) location fix (e.g., 624 in FIG. 6), the UE 502 may be configured to provide the indication 510 (e.g., 706 in FIG. 7; 808 in FIG. 8; 914 in FIG. 9; 1006 in FIG. 10; 1120 in FIG. 11; 1218 in FIG. 12) of the regional communication code of the second region (e.g., 610 in FIG. 6) further based on at least one of (i) a latest one of the updated elapsed times (e.g., 628 in FIG. 6; 720 in FIG. 7; 816 in FIG. 8; 920 in FIG. 9) being greater than or equal to a minimum time threshold (e.g., 812 in FIG. 8; 1022 in FIG. 10; 1118 in FIG. 11) after the elapsed time (e.g., 628 in FIG. 6; 720 in FIG. 7; 816 in FIG. 8; 920 in FIG. 9) plus a time offset (e.g., 718 in FIG. 7; 814 in FIG. 8; 918 in FIG. 9), (ii) the location (e.g., 624 in FIG. 6) of the UE being in the second region (e.g., 610 in FIG. 6), or (iii) the current heading (e.g., 630 in FIG. 6) of the vehicle (e.g., 620 in FIG. 6; 1106 in FIG. 11; 1206 in FIG. 12) associated with the UE 502. In some aspects, the UE 502 may be configured to provide the indication 510 (e.g., 706 in FIG. 7; 808 in FIG. 8; 914 in FIG. 9; 1006 in FIG. 10; 1120 in FIG. 11; 1218 in FIG. 12) based on historical information (e.g., 1008 in FIG. 10) associated with the UE 502, e.g., trip history information (e.g., 1010 in FIG. 10) of the UE 502/vehicle (e.g., 620 in FIG. 6; 1106 in FIG. 11; 1206 in FIG. 12), map geometry (e.g., 1012 in FIG. 10), road geometry (e.g., 1014 in FIG. 10), cell history information (e.g., 1016 in FIG. 10), and/or the like.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the component 198 may be configured to calculate a set of distances from a location of the UE to at least one crossing of a border between a first region and a second region, where the UE is initially located in the first region, where the set of distances is based on a corresponding set of border points and a GNSS location fix for the UE. The component 198 may be configured to estimate an elapsed time at which the UE crossed the border based on at least one of a current heading of a vehicle associated with the UE, at least one distance of the set of distances, or a current speed of the UE. The component 198 may be configured to provide, for a network entity and based on the elapsed time at which the UE crossed the border and a crossing threshold condition, an indication of a regional communication code of the second region associated with roaming of the UE in the second region. The component 198 may be configured to obtain traffic information associated with the vehicle associated with the UE. The component 198 may be configured to identify that the location of the UE is in the second region based on an updated GNSS location fix. The component 198 may be configured to increase a time interval for calculating distances of the set of distances from the location of the UE to the at least one crossing of the border between the first region and the second region. The component 198 may be configured to calculate another set of distances from the location of the UE to the at least one crossing of the border between the first region and the second region. The component 198 may be configured to estimate another elapsed time at which the UE crossed the border based on at least one of another current heading of the vehicle associated with the UE, at least one other distance of the another set of distances, or another current speed of the UE. The component 198 may be configured to obtain, from an inference engine and based on at least one vehicle camera input of a camera of the vehicle, an inference of a road traffic status for a road associated with the UE of the vehicle, where the inference of the road traffic status indicates an amount of traffic that meets a traffic threshold condition. The component 198 may be configured to obtain, based on at least one vehicle camera input of a camera of the vehicle, a road indication of a road type or a road geometry for a road associated with the UE of the vehicle. The component 198 may be configured to identify that the location of the UE is in the first region based on an updated GNSS location fix. The component 198 may be configured to obtain, based on at least one vehicle camera input of a camera of the vehicle, a sign indication of a road sign for a road associated with the UE of the vehicle, where the sign indication of the road sign is indicative of a distance from the location of the UE to the at least one crossing of the border between the first region and the second region. The component 198 may be configured to receive, from the network entity, a configuration indicative of a switch to a cell associated with the regional communication code of the second region. The component 198 may be configured to switch to the cell based on the configuration. The component 198 may be further configured to perform any of the aspects described in connection with the flowcharts in FIG. 13 and/or any of the aspects performed by a UE for any of FIGS. 5-12. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for calculating a set of distances from a location of the UE to at least one crossing of a border between a first region and a second region, where the UE is initially located in the first region, where the set of distances is based on a corresponding set of border points and a GNSS location fix for the UE. In the configuration, the apparatus 1404, and in particular the cellular baseband processor(s) 1424 and/or the application processor(s) 1406, may include means for estimating an elapsed time at which the UE crossed the border based on at least one of a current heading of a vehicle associated with the UE, at least one distance of the set of distances, or a current speed of the UE. In the configuration, the apparatus 1404, and in particular the cellular baseband processor(s) 1424 and/or the application processor(s) 1406, may include means for providing, for a network entity and based on the elapsed time at which the UE crossed the border and a crossing threshold condition, an indication of a regional communication code of the second region associated with roaming of the UE in the second region. In one configuration, the apparatus 1404, and in particular the cellular baseband processor(s) 1424 and/or the application processor(s) 1406, may include means for obtaining traffic information associated with the vehicle associated with the UE. In one configuration, the apparatus 1404, and in particular the cellular baseband processor(s) 1424 and/or the application processor(s) 1406, may include means for identifying that the location of the UE is in the second region based on an updated GNSS location fix. In one configuration, the apparatus 1404, and in particular the cellular baseband processor(s) 1424 and/or the application processor(s) 1406, may include means for increasing a time interval for calculating distances of the set of distances from the location of the UE to the at least one crossing of the border between the first region and the second region. In one configuration, the apparatus 1404, and in particular the cellular baseband processor(s) 1424 and/or the application processor(s) 1406, may include means for calculating another set of distances from the location of the UE to the at least one crossing of the border between the first region and the second region. In one configuration, the apparatus 1404, and in particular the cellular baseband processor(s) 1424 and/or the application processor(s) 1406, may include means for estimating another elapsed time at which the UE crossed the border based on at least one of another current heading of the vehicle associated with the UE, at least one other distance of the another set of distances, or another current speed of the UE. In one configuration, the apparatus 1404, and in particular the cellular baseband processor(s) 1424 and/or the application processor(s) 1406, may include means for obtaining, from an inference engine and based on at least one vehicle camera input of a camera of the vehicle, an inference of a road traffic status for a road associated with the UE of the vehicle, where the inference of the road traffic status indicates an amount of traffic that meets a traffic threshold condition. In one configuration, the apparatus 1404, and in particular the cellular baseband processor(s) 1424 and/or the application processor(s) 1406, may include means for obtaining, based on at least one vehicle camera input of a camera of the vehicle, a road indication of a road type or a road geometry for a road associated with the UE of the vehicle. In one configuration, the apparatus 1404, and in particular the cellular baseband processor(s) 1424 and/or the application processor(s) 1406, may include means for identifying that the location of the UE is in the first region based on an updated GNSS location fix. In one configuration, the apparatus 1404, and in particular the cellular baseband processor(s) 1424 and/or the application processor(s) 1406, may include means for obtaining, based on at least one vehicle camera input of a camera of the vehicle, a sign indication of a road sign for a road associated with the UE of the vehicle, where the sign indication of the road sign is indicative of a distance from the location of the UE to the at least one crossing of the border between the first region and the second region. In one configuration, the apparatus 1404, and in particular the cellular baseband processor(s) 1424 and/or the application processor(s) 1406, may include means for receiving, from the network entity, a configuration indicative of a switch to a cell associated with the regional communication code of the second region. In one configuration, the apparatus 1404, and in particular the cellular baseband processor(s) 1424 and/or the application processor(s) 1406, may include means for switching to the cell based on the configuration. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

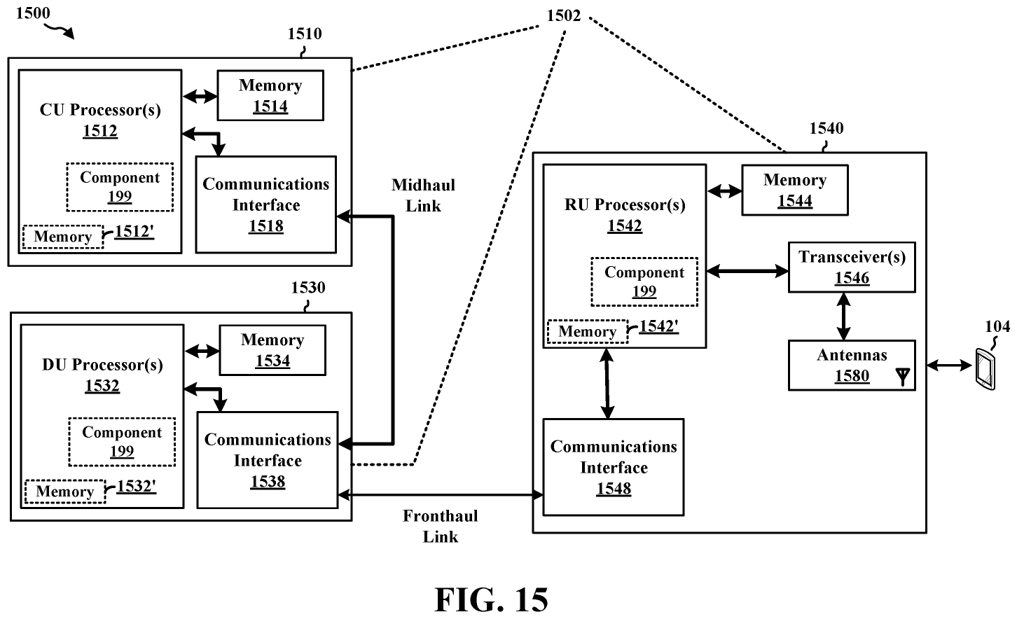

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a UE and based on an elapsed time at which the UE crossed a border from a first region to a second region and a crossing threshold condition, an indication of a regional communication code of the second region associated with roaming of the UE in the second region. The component 199 may be configured to provide, for the UE and based on the indication of the regional communication code of the second region, a configuration indicative of a switch to a cell associated with the regional communication code of the second region. The component 199 may be configured to communicate with the UE based on the switch to the cell. The component 199 may be further configured to perform any of the aspects described in connection with the flowcharts in FIG. 13 and/or any of the aspects performed by a network entity/node for any of FIGS. 5-12. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for receiving, from a UE and based on an elapsed time at which the UE crossed a border from a first region to a second region and a crossing threshold condition, an indication of a regional communication code of the second region associated with roaming of the UE in the second region. In the configuration, the network entity 1502 may include means for providing, for the UE and based on the indication of the regional communication code of the second region, a configuration indicative of a switch to a cell associated with the regional communication code of the second region. In the configuration, the network entity 1502 may include means for communicating with the UE based on the switch to the cell. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

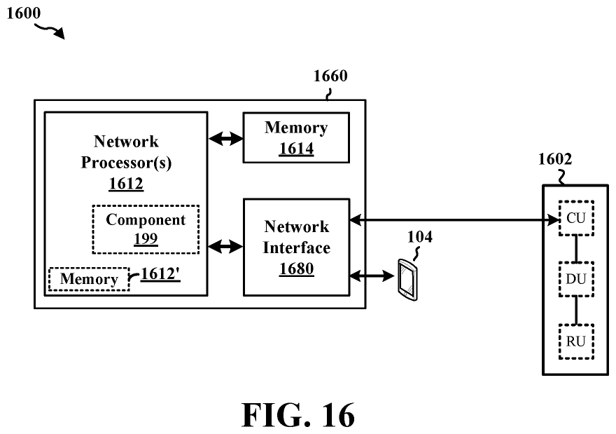

FIG. 16 is a diagram 1600 illustrating an example of a hardware implementation for a network entity 1660. In one example, the network entity 1660 may be within the core network 120. The network entity 1660 may include at least one network processor 1612. The network processor(s) 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602. The on-chip memory 1612′ and the additional memory modules 1614 may each be considered a computer-readable medium/memory. Each computer-readable medium/memory may be non-transitory. The network processor(s) 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a UE and based on an elapsed time at which the UE crossed a border from a first region to a second region and a crossing threshold condition, an indication of a regional communication code of the second region associated with roaming of the UE in the second region. The component 199 may be configured to provide, for the UE and based on the indication of the regional communication code of the second region, a configuration indicative of a switch to a cell associated with the regional communication code of the second region. The component 199 may be configured to communicate with the UE based on the switch to the cell. The component 199 may be further configured to perform any of the aspects described in connection with the flowcharts in FIG. 13 and/or any of the aspects performed by a network entity/node for any of FIGS. 5-12. The component 199 may be within the network processor(s) 1612. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1660 may include a variety of components configured for various functions. In one configuration, the network entity 1660 may include means for receiving, from a UE and based on an elapsed time at which the UE crossed a border from a first region to a second region and a crossing threshold condition, an indication of a regional communication code of the second region associated with roaming of the UE in the second region. In the configuration, the network entity 1660 may include means for providing, for the UE and based on the indication of the regional communication code of the second region, a configuration indicative of a switch to a cell associated with the regional communication code of the second region. In the configuration, the network entity 1660 may include means for communicating with the UE based on the switch to the cell. The means may be the component 199 of the network entity 1660 configured to perform the functions recited by the means.

A network node/entity and a UE in a wireless communication network may communicate in various configurations to account for UE mobility. As an example, a UE may connect to a roaming cell when the UE moves into a different region, such as a different country via a land border crossing. However, PLMN selection and RAT/frequency band scans during land border crossings may lead to service loss and interruption based on roaming agreements and cross-border network setups. As one example, this may adversely impact certain connected vehicle services with service continuity considerations such as tele-operated driving. Additionally, false-positive border crossing indications and lack of granularity in determinations for border approaches/crossings may decrease reliability and speed of border crossing detections. Further, when a UE simply utilizes GNSS fixes and a straight-line distance to a border region, e.g., for a vehicular UE, to detect when the UE is in a new region/country, considerations such as road geometry/traffic situations, vehicle heading/direction, etc., that are not accounted for may lead to scenarios in which the detection time may be delayed (or in which triggering conditions would not be met), and the UE may fall back to prior PLMN searches, further delaying service.

The aspects herein for vehicle information aided roaming and PLMN selection in vehicular UEs for border crossings may enable a UE to utilize GNSS fixes to prompt a modem to trigger an indication of a new regional communication code, e.g., an MCC, to an upper network layer(s) for scanning RATs/frequency bands (e.g., full/limited) based on the new region/country band policy when the UE is further than a given distance inside the different/new region or country. Aspects also provide for available vehicle sensor information (e.g., vehicle heading/trajectory), navigation information (e.g., history or real-time information, such as vehicle route/trip information, road geometry/traffic information, etc.), and vehicle camera information (e.g., for road images, road traffic signs, and/or the like), in addition to GNSS information (e.g., vehicle location and speed, etc.) to be utilized to enable a modem to more quickly and accurately select a PLMN in a new region/country when a vehicle UE is crossing the region/country border by land. Aspects improve the reliability of border mode determinations for vehicular UEs by incorporating additional information with GNSS fixes. Aspects also improve the performance as well as the accuracy of border mode determinations for vehicular UEs, such as lower threshold distances for border crossing detections, by incorporating vehicle information together with UE cell history, vehicle trip history, and/or road geometry/characteristics information.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof′ include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), comprising: calculating a set of distances from a location of the UE to at least one crossing of a border between a first region and a second region, wherein the UE is initially located in the first region, wherein the set of distances is based on a corresponding set of border points and a global navigation satellite system (GNSS) location fix for the UE; estimating an elapsed time at which the UE crossed the border based on at least one of a current heading of a vehicle associated with the UE, at least one distance of the set of distances, or a current speed of the UE; and providing, for a network entity and based on the elapsed time at which the UE crossed the border and a crossing threshold condition, an indication of a regional communication code of the second region associated with roaming of the UE in the second region.
Aspect 2 is the method of aspect 1, wherein calculating the set of distances from the location of the UE to the at least one crossing of the border between the first region and the second region includes periodically calculating the set of distances based on a dynamic periodicity, wherein the dynamic periodicity is adjusted based on the elapsed time estimated at which the UE crossed the border and a periodicity threshold condition; wherein estimating the elapsed time at which the UE crossed the border includes estimating updated elapsed times at which the UE crossed the border for each performance of periodically calculating the set of distances.
Aspect 3 is the method of aspect 2, wherein the periodicity threshold condition is met when the elapsed time at which the UE crossed the border is less than or equal to a trigger time minus a time offset.
Aspect 4 is the method of any of aspects 2 and 3, further comprising: obtaining traffic information associated with the vehicle associated with the UE; wherein the dynamic periodicity is adjusted further based on the traffic information and the current heading of the vehicle associated with the UE being indicative of UE movement away from a crossing of the at least one crossing of the border at which the UE crossed the border.
Aspect 5 is the method of any of aspects 2 to 4, further comprising: identifying that the location of the UE is in the second region based on an updated GNSS location fix; wherein providing the indication of the regional communication code of the second region is further based on at least one of (i) a latest one of the updated elapsed times being greater than or equal to a minimum time threshold after the elapsed time plus a time offset, (ii) the location of the UE being in the second region, or (iii) the current heading of the vehicle associated with the UE.
Aspect 6 is the method of aspect 5, wherein estimating the elapsed time at which the UE crossed the border includes estimating a set of elapsed times at which the UE crossed the border respectively associated with one or more distances of the set of distances; wherein for a number of preceding elapsed times of the set of elapsed times: the elapsed time is greater than the minimum time threshold after the elapsed time plus the time offset, the location of the UE is in the second region, and the current heading of the vehicle associated with the UE is indicative of UE movement that is away from a crossing of the at least one crossing of the border at which the UE crossed the border.
Aspect 7 is the method of aspect 6, wherein providing the indication of the regional communication code of the second region is further based on a confidence level associated with at least one of an average or a standard deviation of the number of preceding elapsed times of the set of elapsed times.
Aspect 8 is the method of aspect 5, wherein estimating the elapsed time at which the UE crossed the border includes estimating a set of elapsed times at which the UE crossed the border respectively associated with one or more distances of the set of distances; wherein for a number of preceding elapsed times of the set of elapsed times: the elapsed time is greater than or equal to the periodicity threshold condition minus the time offset, the location of the UE is in the first region, and the current heading of the vehicle associated with the UE is indicative of UE movement that is away from a crossing of the at least one crossing of the border; wherein the method further comprises: increasing a time interval for calculating distances of the set of distances from the location of the UE to the at least one crossing of the border between the first region and the second region.
Aspect 9 is the method of aspect 8, further comprising, subsequent to estimating the set of elapsed times: calculating another set of distances from the location of the UE to the at least one crossing of the border between the first region and the second region; and estimating another elapsed time at which the UE crossed the border based on at least one of another current heading of the vehicle associated with the UE, at least one other distance of the another set of distances, or another current speed of the UE; wherein providing the indication of the regional communication code of the second region associated with the roaming of the UE in the second region includes providing the indication of the regional communication code of the second region associated with the roaming of the UE in the second region based on the another elapsed time at which the UE crossed the border and the crossing threshold condition.
Aspect 10 is the method of any of aspects 8 and 9, wherein providing the indication of the regional communication code of the second region is further based on a confidence level associated with at least one of an average or a standard deviation of the number of preceding elapsed times of the set of elapsed times.
Aspect 11 is the method of any of aspects 5 to 10, wherein the indication of the regional communication code of the second region is based on historical information, wherein the historical information includes at least one of trip history information associated with the UE, a map geometry, a road geometry, or cell history information associated with the UE.
Aspect 12 is the method of aspect 11, wherein the cell history information associated with the UE includes at least one of a public land mobile network (PLMN) of a last serving cell for the UE in the second region, a cell identity of the last serving cell for the UE in the second region, a roaming transition identifier, a number of times the UE has traversed the border, or another number of times the UE has traversed the border over a period of time; wherein the cell history information associated with the UE is based on a UE-record or is based on a crowdsourcing data associated with a cloud-based entity.
Aspect 13 is the method of any of aspects 11 and 12, wherein the minimum time threshold after the elapsed time is a reduced value based on the historical information.
Aspect 14 is the method of any of aspects 5 to 13, further comprising: obtaining, from an inference engine and based on at least one vehicle camera input of a camera of the vehicle, an inference of a road traffic status for a road associated with the UE of the vehicle, wherein the inference of the road traffic status indicates an amount of traffic that meets a traffic threshold condition; and wherein the minimum time threshold after the elapsed time is a reduced value based on the inference of the road traffic status, or wherein providing the indication of the regional communication code of the second region is further based on a distance of the set of distances that meets a distance threshold condition associated with the at least one crossing of the border between the first region and the second region, wherein the distance threshold condition is a reduced condition based on the inference of the road traffic status.
Aspect 15 is the method of any of aspects 5 to 14, further comprising: obtaining, based on at least one vehicle camera input of a camera of the vehicle, a road indication of a road type or a road geometry for a road associated with the UE of the vehicle; and wherein the minimum time threshold after the elapsed time is a reduced value based on the road indication of the road type or the road geometry, or wherein providing the indication of the regional communication code of the second region is further based on a distance of the set of distances that meets a distance threshold condition associated with the at least one crossing of the border between the first region and the second region, wherein the distance threshold condition is a reduced condition based on the road indication of the road type or the road geometry.
Aspect 16 is the method of any of aspects 2 to 15, further comprising: identifying that the location of the UE is in the first region based on an updated GNSS location fix; and obtaining, based on at least one vehicle camera input of a camera of the vehicle, a sign indication of a road sign for a road associated with the UE of the vehicle, wherein the sign indication of the road sign is indicative of a distance from the location of the UE to the at least one crossing of the border between the first region and the second region; wherein estimating the elapsed time at which the UE crossed the border is further based on the distance from the location of the UE to the at least one crossing of the border between the first region and the second region, or wherein periodically calculating the set of distances based on the dynamic periodicity is further based on the distance from the location of the UE to the at least one crossing of the border between the first region and the second region.
Aspect 17 is the method of any of aspects 1 to 16, wherein the UE comprises the vehicle.
Aspect 18 is the method of any of aspects 1 to 17, further comprising: receiving, from the network entity, a configuration indicative of a switch to a cell associated with the regional communication code of the second region; and switching to the cell based on the configuration.
Aspect 19 is an apparatus for wireless communication at a user equipment (UE), comprising: at least one memory; and at least one processor coupled to the at least one memory, the at least one processor, individually or in any combination, is configured to perform the method of any of aspects 1 to 18.
Aspect 20 is an apparatus for wireless communication at a user equipment (UE), comprising means for performing each step in the method of any of aspects 1 to 18.
Aspect 21 is the apparatus of any of aspects 19 and 20, further comprising a transceiver configured to receive or to transmit in association with the method of any of aspects 1 to 18.
Aspect 22 is a computer-readable medium (e.g., a non-transitory computer-readable medium) storing computer executable code a user equipment (UE), the code when executed by at least one processor causes the UE to perform the method of any of aspects 1 to 18.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
calculate a set of distances from a location of the UE to at least one crossing of a border between a first region and a second region, wherein the UE is initially located in the first region, wherein the set of distances is based on a corresponding set of border points and a global navigation satellite system (GNSS) location fix for the UE;
estimate an elapsed time at which the UE crossed the border based on at least one of a current heading of a vehicle associated with the UE, at least one distance of the set of distances, or a current speed of the UE; and
provide, for a network entity and based on the elapsed time at which the UE crossed the border and a crossing threshold condition, an indication of a regional communication code of the second region associated with roaming of the UE in the second region.

2. The apparatus of claim 1, wherein to calculate the set of distances from the location of the UE to the at least one crossing of the border between the first region and the second region, the at least one processor, individually or in any combination, is configured to periodically calculate the set of distances based on a dynamic periodicity, wherein the dynamic periodicity is adjusted based on the elapsed time estimated at which the UE crossed the border and a periodicity threshold condition;
wherein to estimate the elapsed time at which the UE crossed the border, the at least one processor, individually or in any combination, is configured to estimate updated elapsed times at which the UE crossed the border for each performance of periodically calculating the set of distances.

3. The apparatus of claim 2, wherein the periodicity threshold condition is met when the elapsed time at which the UE crossed the border is less than or equal to a trigger time minus a time offset.

4. The apparatus of claim 2, wherein the at least one processor, individually or in any combination, is further configured to:
obtain traffic information associated with the vehicle associated with the UE;
wherein the dynamic periodicity is adjusted further based on the traffic information and the current heading of the vehicle associated with the UE being indicative of UE movement away from a crossing of the at least one crossing of the border at which the UE crossed the border.

5. The apparatus of claim 2, wherein the at least one processor, individually or in any combination, is further configured to:
identify that the location of the UE is in the second region based on an updated GNSS location fix;
wherein to provide the indication of the regional communication code of the second region, the at least one processor, individually or in any combination, is configured to provide the indication further based on at least one of (i) a latest one of the updated elapsed times being greater than or equal to a minimum time threshold after the elapsed time plus a time offset, (ii) the location of the UE being in the second region, or (iii) the current heading of the vehicle associated with the UE.

6. The apparatus of claim 5, wherein to estimate the elapsed time at which the UE crossed the border, the at least one processor, individually or in any combination, is configured to estimate a set of elapsed times at which the UE crossed the border respectively associated with one or more distances of the set of distances;
wherein for a number of preceding elapsed times of the set of elapsed times:
the elapsed time is greater than the minimum time threshold after the elapsed time plus the time offset,
the location of the UE is in the second region, and
the current heading of the vehicle associated with the UE is indicative of UE movement that is away from a crossing of the at least one crossing of the border at which the UE crossed the border.

7. The apparatus of claim 6, wherein to provide the indication of the regional communication code of the second region, the at least one processor, individually or in any combination, is configured to provide the indication further based on a confidence level associated with at least one of an average or a standard deviation of the number of preceding elapsed times of the set of elapsed times.

8. The apparatus of claim 5, wherein to estimate the elapsed time at which the UE crossed the border, the at least one processor, individually or in any combination, is configured to estimate a set of elapsed times at which the UE crossed the border respectively associated with one or more distances of the set of distances;
wherein for a number of preceding elapsed times of the set of elapsed times:
the elapsed time is greater than or equal to the periodicity threshold condition minus the time offset,
the location of the UE is in the first region, and
the current heading of the vehicle associated with the UE is indicative of UE movement that is away from a crossing of the at least one crossing of the border;
wherein the at least one processor, individually or in any combination, is further configured to:
increase a time interval for calculating distances of the set of distances from the location of the UE to the at least one crossing of the border between the first region and the second region.

9. The apparatus of claim 8, wherein the at least one processor, individually or in any combination, subsequent to the estimation of the set of elapsed times, is further configured to:
calculate another set of distances from the location of the UE to the at least one crossing of the border between the first region and the second region; and
estimate another elapsed time at which the UE crossed the border based on at least one of another current heading of the vehicle associated with the UE, at least one other distance of the another set of distances, or another current speed of the UE;
wherein to provide the indication of the regional communication code of the second region associated with the roaming of the UE in the second region, the at least one processor, individually or in any combination, is configured to provide the indication of the regional communication code of the second region associated with the roaming of the UE in the second region based on the another elapsed time at which the UE crossed the border and the crossing threshold condition.

10. The apparatus of claim 8, wherein to provide the indication of the regional communication code of the second region, the at least one processor, individually or in any combination, is configured to provide the indication further based on a confidence level associated with at least one of an average or a standard deviation of the number of preceding elapsed times of the set of elapsed times.

11. The apparatus of claim 5, wherein the indication of the regional communication code of the second region is based on historical information, wherein the historical information includes at least one of trip history information associated with the UE, a map geometry, a road geometry, or cell history information associated with the UE.

12. The apparatus of claim 11, wherein the cell history information associated with the UE includes at least one of a public land mobile network (PLMN) of a last serving cell for the UE in the second region, a cell identity of the last serving cell for the UE in the second region, a roaming transition identifier, a number of times the UE has traversed the border, or another number of times the UE has traversed the border over a period of time;
wherein the cell history information associated with the UE is based on a UE record or is based on a crowdsourcing data associated with a cloud-based entity.

13. The apparatus of claim 11, wherein the minimum time threshold after the elapsed time is a reduced value based on the historical information.

14. The apparatus of claim 5, wherein the at least one processor, individually or in any combination, is further configured to:
obtain, from an inference engine and based on at least one vehicle camera input of a camera of the vehicle, an inference of a road traffic status for a road associated with the UE of the vehicle, wherein the inference of the road traffic status indicates an amount of traffic that meets a traffic threshold condition; and
wherein the minimum time threshold after the elapsed time is a reduced value based on the inference of the road traffic status, or
wherein to provide the indication of the regional communication code of the second region, the at least one processor, individually or in any combination, is configured to provide the indication further based on a distance of the set of distances that meets a distance threshold condition associated with the at least one crossing of the border between the first region and the second region, wherein the distance threshold condition is a reduced condition based on the inference of the road traffic status.

15. The apparatus of claim 5, wherein the at least one processor, individually or in any combination, is further configured to:
obtain, based on at least one vehicle camera input of a camera of the vehicle, a road indication of a road type or a road geometry for a road associated with the UE of the vehicle; and
wherein the minimum time threshold after the elapsed time is a reduced value based on the road indication of the road type or the road geometry, or
wherein to provide the indication of the regional communication code of the second region, the at least one processor, individually or in any combination, is configured to provide the indication further based on a distance of the set of distances that meets a distance threshold condition associated with the at least one crossing of the border between the first region and the second region, wherein the distance threshold condition is a reduced condition based on the road indication of the road type or the road geometry.

16. The apparatus of claim 2, wherein the at least one processor, individually or in any combination, is further configured to:
identify that the location of the UE is in the first region based on an updated GNSS location fix; and
obtain, based on at least one vehicle camera input of a camera of the vehicle, a sign indication of a road sign for a road associated with the UE of the vehicle, wherein the sign indication of the road sign is indicative of a distance from the location of the UE to the at least one crossing of the border between the first region and the second region;
wherein to estimate the elapsed time at which the UE crossed the border, the at least one processor, individually or in any combination, is configured to estimate the elapsed time further based on the distance from the location of the UE to the at least one crossing of the border between the first region and the second region, or wherein to periodically calculate the set of distances based on the dynamic periodicity, the at least one processor, individually or in any combination, is configured to periodically calculate the set of distances further based on the distance from the location of the UE to the at least one crossing of the border between the first region and the second region.

17. The apparatus of claim 1, wherein the UE comprises the vehicle.

18. The apparatus of claim 1, further comprising a transceiver coupled to the at least one processor;
wherein the at least one processor, individually or in any combination, is further configured to:
receive, from the network entity via the transceiver, a configuration indicative of a switch to a cell associated with the regional communication code of the second region; and
switch to the cell based on the configuration.

19. A method of wireless communication at a user equipment (UE), comprising:
calculating a set of distances from a location of the UE to at least one crossing of a border between a first region and a second region, wherein the UE is initially located in the first region, wherein the set of distances is based on a corresponding set of border points and a global navigation satellite system (GNSS) location fix for the UE;
estimating an elapsed time at which the UE crossed the border based on at least one of a current heading of a vehicle associated with the UE, at least one distance of the set of distances, or a current speed of the UE; and
providing, for a network entity and based on the elapsed time at which the UE crossed the border and a crossing threshold condition, an indication of a regional communication code of the second region associated with roaming of the UE in the second region.

20. A computer-readable medium storing computer executable code at a user equipment (UE), the code when executed by at least one processor causes the at least one processor to:
calculate a set of distances from a location of the UE to at least one crossing of a border between a first region and a second region, wherein the UE is initially located in the first region, wherein the set of distances is based on a corresponding set of border points and a global navigation satellite system (GNSS) location fix for the UE;
estimate an elapsed time at which the UE crossed the border based on at least one of a current heading of a vehicle associated with the UE, at least one distance of the set of distances, or a current speed of the UE; and
provide, for a network entity and based on the elapsed time at which the UE crossed the border and a crossing threshold condition, an indication of a regional communication code of the second region associated with roaming of the UE in the second region.
